(19) United States
(12) Patent Application Publication
(10) Pub. No.: US 2002/0040431 A1
(43) Pub. Date: Apr. 4, 2002

(54) Computer program product and method for exchanging XML signature

(76) Inventors: Takehisa Kato, Kunitachi-shi (JP); Hidekazu Nishizawa, Machida-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/953,296

(22) Filed: Sep. 17, 2001

(30) Foreign Application Priority Data
Sep. 19, 2000 (JP) 2000-284273

(51) Int. Cl. H04L 9/30

(52) U.S. Cl. 713/168; 713/176

(57) ABSTRACT

According to some of the embodiments of the present invention, there is provided software for carrying out a function for assigning/verifying an XML signature relevant to an XML document, and this software is connected to a Web browser. That is, the function for assigning/verifying the XML signature is used in common, and a portion specialized for each of applications is obtained as only a process for creating an XML document. In this manner, an XML signature can be assigned and/or verified over a Web browser relevant to an XML document created by an arbitrary application, and convenience can be improved.

### CROSS-REFERENCE TO RELATED APPLICATIONS

This application is based upon and claims the benefit of priority from the prior Japanese Patent Application No. 2000-284273, filed Sep. 19, 2000, the entire contents of which are incorporated herein by reference.

### BACKGROUND OF THE INVENTION

1. Field of the Invention

The present invention relates to a computer program product and a method for exchanging an XML signature for exchanging an XML document by E-commerce and electronic application over Internet.

2. Description of the Related Art

In general, in E-commerce or electronic application and the like over Internet, It is recognized that a system capable of assigning electronic signature to a document to be exchanged is effective from the viewpoint of safely exchanging a document concerning a transaction, and at the same time, providing problems after such exchange.

On the other hand, as an associated technology, standardization of XLM (extensible markup language) and standardization of XML-Signature is advanced by a W3C (world wide web consortium). Concurrently, a safe electronic E-commerce/electronic application system caused by an XML document on which a signature is applied over Internet is constructed or fabricated.

However, the above described E-commerce/electronic application system has not the following disadvantages in view of discussion of the Inventor.

That is, the previously described E-commerce/electronic application system requires applications corresponding to XML and specialized for businesses or transaction, and thus, is limited to a large-scale system including B to B (business to business) or G to B (government to business).

On the other hand, in the case where a general consumer such as B to C (business to consumer) or G to C (government to consumer) is a target, from the viewpoint of easiness of customer's utilization, it is required to simply construct a system over a Web browser without any application specialized for businesses or transaction.

However, the Web browser does not have a function for assigning and/or verifying a signature on an XML document. The absence of such a function becomes an obstacle in extending reliable E-commerce/electronic application utilizing an XML signature.

In addition, in software other than Web browser, although a library corresponding to an XML-Signature exists, it is undefined what process is used to assign the XML signature, and a GUI (graphical user interface) is undefined in applying the XML signature.

Therefore, as shown in FIG. 1, unique processing functions (software) Sw1, . . . , Swn, GUI (1). . . , and GUI (n) are developed every application Ap1, . . . , Apn. In this fact, for a user, the XML signature format or operating procedures #1 to #n are different depending on each of the applications Ap1 to Apn, and, for a developer as well, separate XML signature processing functions Sw1 to Swn are provided for each of the applications Ap1 to Apn, which is inconvenient.

### BRIEF SUMMARY OF THE INVENTION

The present invention has been made in order to solve the problem. It is an object of the present to provide a computer program product and a method for exchanging an XML signature capable of achieving an XML signature over a Web browser, and improving convenience relevant to an XML document created by an arbitrary application.

According to a first aspect of the present invention, there is provided a computer program product used for a computer capable of executing a Web browser, the computer program product comprising: a storage medium readable from the computer; and a signature program code stored in the storage medium, the signature program code achieving an XML signature function over the Web browser.

In this manner, an XML signature can be assigned over a Web browser relevant to an XML document created by an arbitrary application, making it possible to improve convenience.

According to a second aspect of the present invention, there is provided a computer program product used for a computer capable of executing a Web browser, the computer program product comprising: a storage medium readable from the computer; and a verification program code stored in the storage medium, the verification program code achieving an XML signature verification function over the Web browser.

In this manner, an XML signature of an XML document can be verified over a Web browser relevant to an XML document processed by an arbitrary application, making it possible to improve convenience.

According to a third aspect of the present invention, there is provided a computer program product used for a computer capable of executing an application having an XML document creating function, the computer program product comprising; a computer readable storage medium that stores a program for applying an XML signature to the created XML document, the computer program product comprising: a first program code for specifying key information used for generating the XML signature; a second program code for adding a index of signature targets to the XML signature; a third program code for, when the XML signature is instructed, using the specified key information, thereby obtaining a summary value targeted for the specified signature, and generating the XML signature that includes the summary value; and a fourth program code for embedding the generated XML signature to an original XML document, and outputting the signed XML document.

Therefore, these program codes are executed by an instruction from an application, whereby advantageous effect similar to the first aspect of the present invention can be easily and reliably provided to an arbitrary stand-alone application.

According to a fourth aspect of the present invention, there is provided a computer program product used for a computer capable of executing an application having an XML document processing function, the computer program product comprising: a computer readable storage medium having stored therein a program for verifying an XML signature included in the XML document, the computer program product comprising; a first program code for syntax analyzing the received XML document; a second program code for, when the XML document includes an XML signature as a result of the syntax analysis, verifying the XML signature, and outputting the verification result; a third program code for, when the verification is carried out, outputting the fact of signature verification disable to a signature target of signature verification disable; and a fourth program code for, when a location targeted for signature is specified, reading the specified signature target, verifying the XML signature, and outputting the verification result.

In this manner, advantageous effect similar to the second aspect of the present invention can be easily and reliably provided to an arbitrary stand-alone application.

According to a fifth aspect of the present invention there is provided a method for exchanging an XML signature over Internet carried out between a Web server for providing a home page and a Web browser capable of inputting information by browsing the home page, the Web server comprising: when a signed XML document is transmitted in which a signed XML document in standard specification is assigned to an XML document generated based on input information over the Web browser, receiving the signed XML document; verifying an XML signature of the received, signed XML document; if the XML signature is valid as a result of the verification, generating an XML document that notified acceptance of the signed XML document; assigning an XML document to this XML document, thereby generating the signed XML document; and transmitting the signed XML document to the Web browser.

In this manner, an XML signature can be assigned over a Web browser relevant to an XML document created by an arbitrary application, convenience can be improved, and further reliability can be improved.

In addition, such arbitrary application concerns businesses such as E-commerce, thereby making it possible to improve convenience or reliability concerning E-commerce. Furthermore, advantageous effect according to similar improvement of convenience or reliability can be achieved according to the contents of an arbitrary application.

According to a sixth aspect of the present invention, there is provided a method for exchanging an XML signature for exchanging an XML document managed by a Web sever, the method comprising: receiving a request for signifying the managed XML document from a client; transmitting the managed XML document to the client; and displaying a screen for prompting selection of the XML document targeted for signature.

In this manner, at the server side, an XML document targeted for signature can be provided to an XML document under management in accordance with a signature request from the client, and convenience can be improved.

According to a seventh aspect of the present invention, there is provided a method for exchanging an XML signature in an ASP (Application Service Provider) service that is established between an ASP's Web server for providing an ASP that includes creation/management of an XML document and a client's Web browser utilizing the ASP service, the method comprising; transmitting an XML document created/managed by the ASP's Web sever to the client's Web browser assigning a signature over the client's Web browser to the received XML document from the ASP's Web server, thereby generating a signed XML document; and returning the signed XML document to the ASP's Web server.

In this manner, at the client side utilizing an ASP service, an XML signature can be assigned over a web browser to the XML document created by an arbitrary application, and convenience can be improved.

According to an eighth aspect of the present invention, there is provided a method for exchanging an XML signature established between an application for creating an XML document with an XML signature template and a signature assigning server for assigning a signature to the XML document, the signature assigning server comprising: storing an XML document with a template received from the application; when a signature assignment permission is received with respect to the stored XML document, assigning the signature to the XML document, thereby generating the signed XML document; and returning the signed XML document to the application.

In this manner, there can be provided an arbitrary processing system for automatically assigning an XML signature at the signature assigning server side, and returning the obtained XML document Ds to the client.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic view showing a conventional software structure;

FIG. 2 is a schematic view showing a concept of an electronic signature system using a signature storage medium according to a first embodiment of the present invention;

FIG. 3 is a schematic view showing a configuration of an XML signature in accordance with the first embodiment;

FIG. 4 is a schematic view showing a method for assigning an XML signature in accordance with the first embodiment;

FIG. 5 is a schematic view showing a software structure extending a function of a Web browser in accordance with the first embodiment;

FIG. 6 is a schematic view showing an use case concerning assignment of signature in accordance with the first embodiment;

FIG. 7 is a sequence diagram illustrating an operation of an electronic signature system in accordance with the first embodiment;

FIG. 8 is a schematic view showing a screen in accordance with the first embodiment;

FIG. 9 is a sequence diagram illustrating an operation of an electronic signature system in accordance with the first embodiment;

FIG. 10 is a schematic view showing a screen in accordance with the first embodiment;

FIG. 11 is a schematic view showing a screen in accordance with the first embodiment;

FIG. 12 is a schematic view showing a software structure that extends a function of a Web browser of an electronic signature device using a signature storage medium according to a second embodiment of the present invention;

FIG. 13 is a schematic view showing an use case concerning verification of signature in accordance with the second embodiment;

FIG. 14 is a sequence diagram illustrating an operation in accordance with the second embodiment;

FIG. 15 is a schematic view showing a screen in accordance with the second embodiment;

FIG. 16 is a schematic view showing a screen in accordance with the second embodiment;

FIG. 17 is a sequence diagram illustrating an operation in accordance with the second embodiment

FIG. 18 is a schematic view showing a modified screen in accordance with the second embodiment

FIG. 19A is a schematic view showing another modified XML document with multiple signature in accordance with the second embodiment;

FIG. 19B is a schematic view showing another modified XML document with multiple signature in accordance with the second embodiment;

FIG. 20 is a schematic view showing a modified screen in accordance with the second embodiment;

FIG. 21 is a schematic view showing a software structure for extending a function an application of an electronic signature device using a signature storage medium according to a third embodiment of the present invention;

FIG. 22 is a schematic view illustrating a conventional general E-commerce;

FIG. 23 is a schematic view showing a process for E-commerce applied to a business method according to a fourth embodiment of the present invention;

FIG. 24 is a schematic view showing a process applied to a business method in an ASP service according to a fifth embodiment of the present invention;

FIG. 25 is a schematic view showing a configuration of a signature assigning system applied to a business method according to a sixth embodiment of the present invention;

FIG. 26 is a schematic view showing an example of an XML document “Dt” with a signature template in accordance with the sixth embodiment; and

FIG. 27 is a schematic view showing a configuration of an authentication table in accordance with the sixth embodiment.

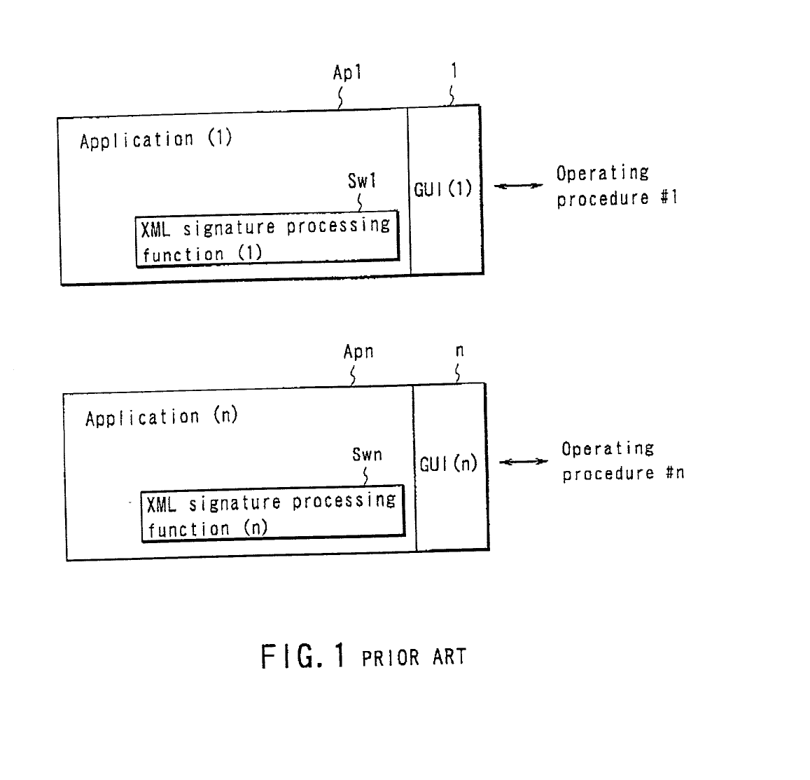

### DETAILED DESCRIPTION OF THE INVENTION

Hereinafter, preferred embodiments of the present invention will be described with reference to the accompanying drawings. In the embodiments each, software for carrying out a function for assigning/verifying an XML signature relevant to an XML document is provided, and this software is connected to a Web browser or an arbitrary application and the like, thereby using the XML signature assigning/verifying function in common, and improving convenience.

In addition, for example, a system application such as E-commerce/electronic application or the like utilizing an XML document is generally composed of the following processes (1) to (4) for:

(1) generating an XML document based on inputted application/transaction information;

(2) assigning a signature to the XML document;

(3) occasionally storing a copy of the signed XL document and

(4) transmitting the signed XML document to an application destination.

Here, only the process for creating an XML document of (1) is specialized for each application. The other processes (2) to (4) are substantially identical to each other every application.

Because of this, the embodiments each extend a function of a Web browser and the Web browser is provided with functions (2) to (4).

In this manner, the service provider may develop only the function of (1) specialized for applications. This development can be easily achieved over the web browser by an “HTML form” function or JavaScript and the like, and thus, a development cost is significantly reduced.

In addition, from the viewpoint of a user only a Web browser comprising the functions of (2) to (4) may be provided, a signature can be assigned and verified by the same GUI, and convenience can be improved.

However, the functions of (2) to (4) may be provided at the server side, as shown in the sixth embodiment, without being limited to the Web browser.

(First Embodiment)

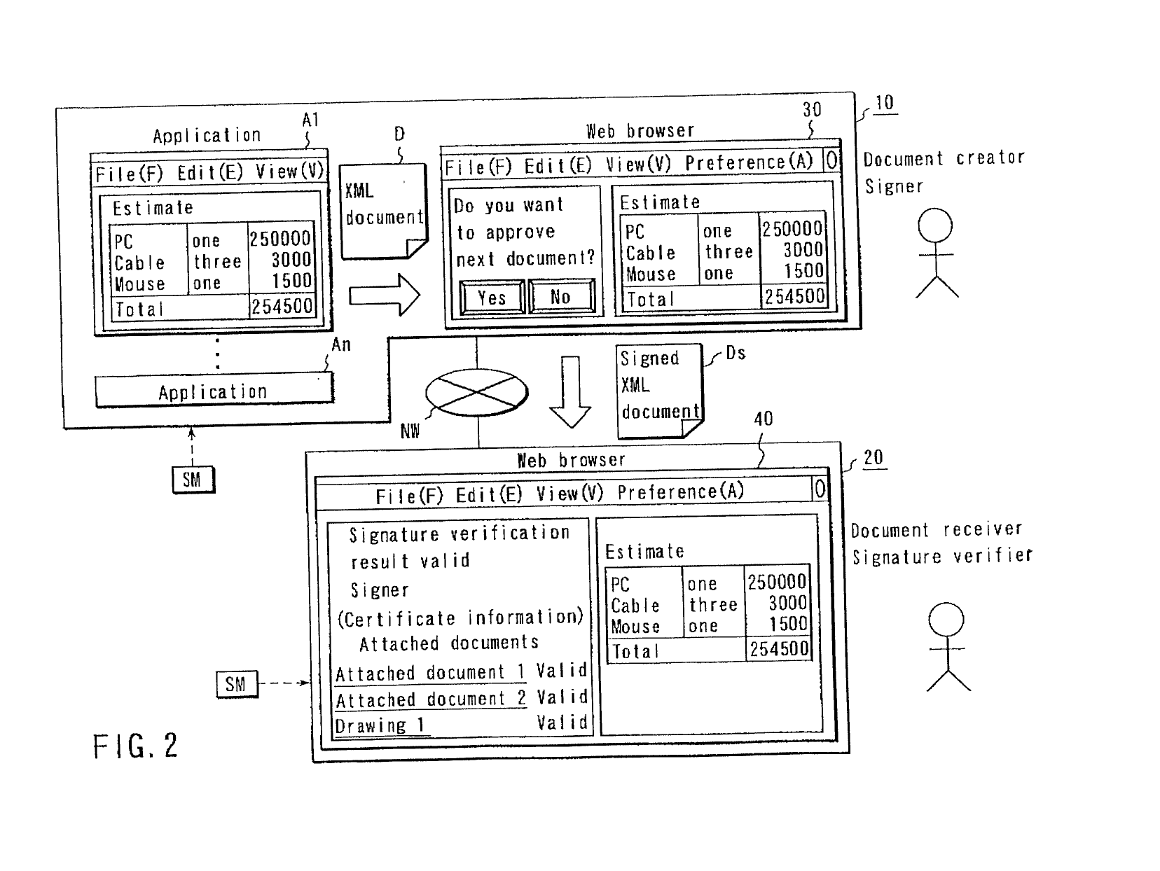

FIG. 2 is a schematic view showing a concept of an electronic signature system using a signature storage medium according to a first embodiment of the present invention. In this electronic signature apparatus, a creator's electronic signature device 10 and a receiver's electronic signature device 20 are connected to each other via Internet NW. The electronic signature devices 10 and 20 each are operable when a program for achieving functions each concerning a signature from a (signature) storage medium SM is installed in advance. In addition, the storage medium SM having such program may be achieved as a computer program product.

Here, the creator's electronic signature device 10 comprises: general computer's functions that includes a function for creating and outputting an XML document D by using any arbitrary one of applications A1 to An and a function for displaying the outputted XML document D over a Web browser 30; a function for assigning an XML signature S to the XML document D via a common GUI over the Web browser 30; and a function for transmitting the obtained, signed XML document Ds to the receiver's electronic signature device 20 by E-mall or “http” (hyper text transfer protocol) and the like.

On the other hand, the receiver's electronic signature device 20 having received a signed XML document Ds have a function for displaying a screen that includes an XML document D over a Web browser 40; and a function for, in the case where the XML document D includes an XML signature S, verifying the XML signature S, and displaying the screen that includes the signature verification result.

Now, an XML document D and an XML document S will be described here.

The XML document D can be displayed over the We browser 30 or 40 in a predetermined format such as chart in accordance with a predetermined CSS (cascading style sheets) file or XSL (extensible style language) file.

Although an arbitrary signature style is applicable, it is preferable that an XML-Signature in which standardization is advanced at W3C is applied from the viewpoint of the face that a signature can be assigned/verified relevant to an arbitrary XML document D without depending on applications A1 to An for generating the XML document D. Hereinafter, the present invention will be described by way of showing an example when XML-Signature is used as an XML signature style. The present invention is applicable to a future specification change without being limited to a specific version of XML-Signature.

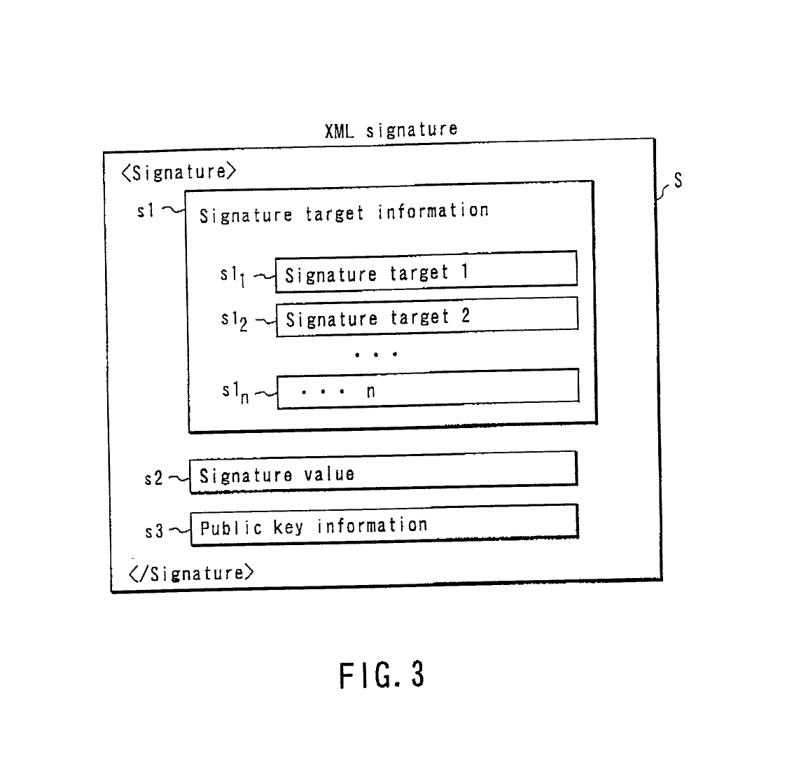

Specifically, as shown in FIG. 3, an XML signature S includes signature target information “s1”, a signature value “s2”, and a public key information “s3”. This signature is represented as an element enclosed in a <Signature>tag.

The signature target information “s1” consists of “n” signature targets s1₁, s1₂, . . . , s1ₙ. The signature targets “s1₁”, “s1₂”, . . . , “s1ₙ” each comprise address information on a signature target or identification information and a summary value of a signature target or a hash value.

The signature value s2 is a value obtained when an electronic signature caused by a secrete key is applied to signature target information s1.

Public key information s3 is obtained as information on a public key used for verification of a signature value s2. Identification information on a signer's public key, for example, a subject name is described.

Although a structure of such XML signature S conforms to XML-Signature specification, another style may be used as long as a structure similar to that shown in FIG. 3 is provided. In addition, the structure of XML signature S itself is specified by W3C or the like, and thus, is excluded from a target of the present invention. The target of the present invention is a business model using a technique for assigning/verifying an electronic signature to the XML document D in conformance with the specification and a function for assigning/verifying an electronic signature of the XML document D.

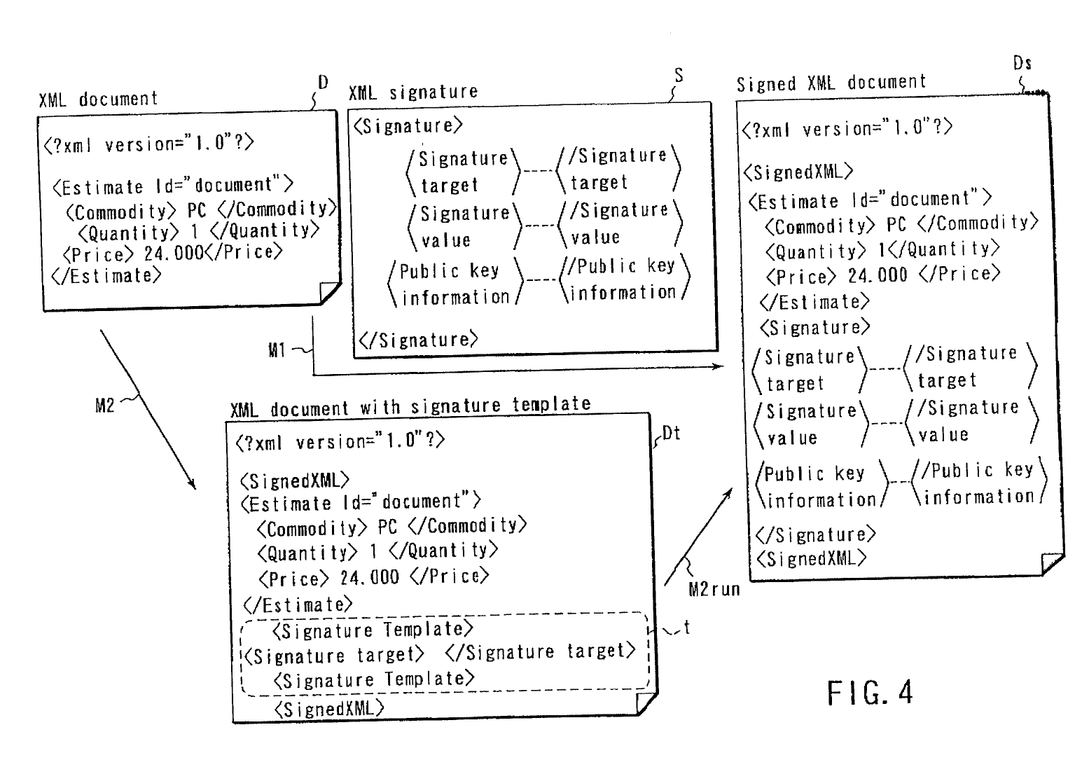

In addition, the XML signature S, as shown in FIG. 4, can be assigned to the XML document D in two methods M1 and M2. The XML-Signature specification specifies only the “Signature” element format, and no method or algorithm for embedding an XML signature S into the XML document D are specified.

As shown in FIG. 4, an XML signature S is inserted into an XML document D being an estimate. A first method M1 is obtained as a method for inserting “Signature” elements that follows “estimate” elements of the XML document D, and enclosing the entirety in a <Signed XML>tag.

The finally prepared document is a signed XML document Ds. As a name of a tag enclosing the entirety, an arbitrary name can be used without being limited to “Signed XML”.

Although the first method M1 can be signed to an arbitrary element of an arbitrary XML document D, it is required to manually designate signature target.

On the other hand, a second method M2 is obtained as a method for generating an XML document Dt with a signature template in advance based on the XML document D. This method inserts index of (signature template “t”) signature target in advance in the same manner as when a signature on a general paper document is described in its predetermined field. This embedding operation for the signature template “t” may be made at the application A1 for generating the XML document D According to the second method M2, when a XML document “Dt” with a signature template is read by the Web browser, it is first checked whether or not a “Signature Template” element is present. In the case where the element is present, a signer is prompted to take an action for signer, and required processing such as decoding computation is carried out. Then, an XML signature S is completed, the contents of the signed XML document Ds are generated, and then, the “Template” element (template portion) may be replaced with a “Signature” element (M2ᵣᵤₙ).

The signature template “t” may have a configuration including public key information in advance instead of a configuration shown in FIG. 4 from the viewpoint of eliminating a process for specifying such public key information.

In addition, verification of signature of a signed XML document Ds is executed by the same processing when any of the first and second methods M1 and M2 is used during signature. In addition, another name may be used as an element name of the signature template “t” as long as the element name is defined in advance.

Now, constituent elements of a creator's electronic signature device 10 will be described here.

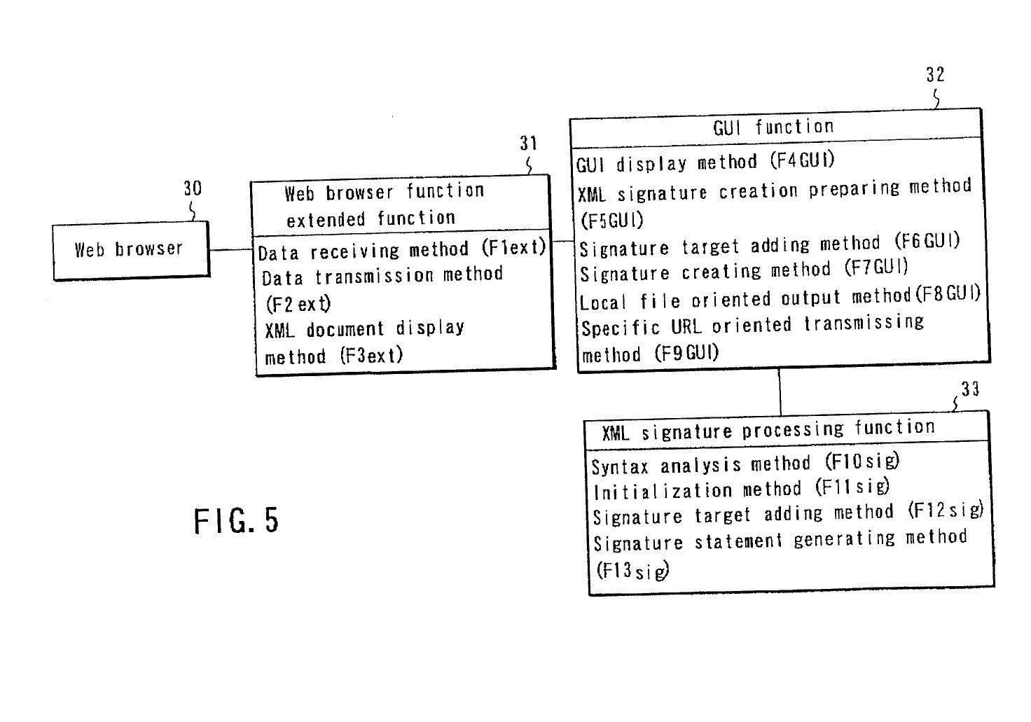

In a Web browser 30, as shown in FIG. 5, functions 31 to 33 for assigning a signature S of the XML document D are extended by adding an application such as plug-in. That is, in the creator's electronic signature device 10, a program for achieving each of the functions 31 to 33 is installed in advance from a storage medium, whereby a function of the Web browser 30 is extended.

Specifically, the Web browser 30 is connected to an XML signature processing function 33 sequentially via the Web browser extended function 31 and GUI function 32.

The Web browser function extended function 31 is provided as a function for obtaining a linkage between the Web browser 30 or GUI function 32 and the XML signature processing function 33. This function comprises data receiving method F1ₑₓₜ, data transmission method F2ₑₓₜ, and XML document display method F3ₑₓₜ.

Thus, the above terms “method” as shown in FIG. 5 correspond to the technical term “method” in the object-oriented programming. In the following description as well, the term “method” belongs to the field of the object-oriented programming. However, the term “method” is not limited to the above definition, may be corresponded to “computer program” without the object-oriented programming.

Here, when data receiving method F1ₑₓₜ is executed by the Web browser 30, receiving method has a function for executing GUI display method FS_{GUI} of the GUI function 32 and a function for delivering the XML document D received from the Web browser 30 to the GUI function 32.

When data transmission method F2ₑₓₜ is executed by specific URL oriented transmission method F9_{GUI}, transmission method has a function for transmitting the signed XML document Ds received from specified URL oriented transmission method F9_{GUI} to an URL specified by specific URL oriented transmission method F9_{GUI}.

XML document display method F3ₑₓₜ has a function for displaying a screen representing an XML document in parallel to a screen for prompting an instruction for assigning the signature S caused by GUI display method F4_{GUI}.

The GUI function 32 is provided as a function for providing an interface with a user. This function comprises GUI display method F4_{GUI}, signature creation preparing method F5_{GUI}, signature target adding method F6_{GUI}, signature creating method F7_{GUI}, local file oriented output method F8_{GUI}, and specific UR oriented transmission method F9_{GUI}.

When GUI display method F4_{GUI} is executed by data receiving method F1ₑₓₜ display method has a function for executing syntax analysis method F10_{sig} of an XML signature processing function 33, a function for displaying a screen prompting for an instruction for assigning a signature to a signer, and a function for displaying a screen concerning storage or transmission, respectively.

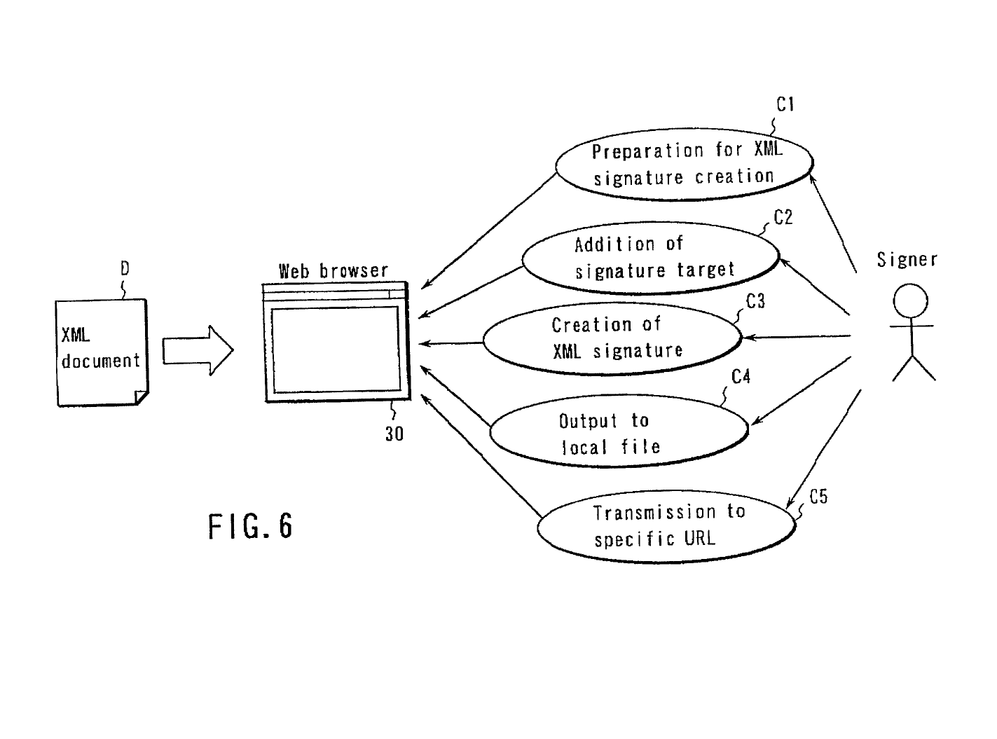

Signature creation preparing method F5_{GUI} carries out an operation C1 concerning initialization, as shown in FIG. 6, before generating the XML signature S. This method has a function for specifying public key information or the like used for a signature S by the signer's input operation or the like and a function for executing initialization method f11_{sig} after this specification.

Signature target adding method F6_{GUI} carries out an operation C2 for specifying an attached document together with a signature target element, as required. This adding method has a function for executing signature target adding method F12_{sig}.

Signature creating method F7_{GUI} carries out an operation C3 for specifying information required for assigning a signature, and then, finally generating an XML signature S. This creating method has a function for executing signature statement generating method F13_{sig}.

Local file oriented output method F8_{GUI} has a function for carrying out an operation C4 stored as a local file on an signer's computer being a receipt of the generated signed XML document Ds.

Specific URL oriented transmission method F9_{GUI} is executed by an operation C5. In other words, the operation C5 executes Specific URL oriented transmission method F9_{GUI} which delivers a signed XML document to a predetermined URL (uniform resource locator) through http protocol or E-mail or like via the transmission method F2ₑₓₜ of the browser function extended function 21. A transmission destination URL may be specified during transmission, and may be specified in advance by a predetermined format or the like.

An XML signature processing function 23 is provided as a function for creating an XML signature S with its structure shown in FIG. 3. This function comprises syntax analysis method F10_{sig}, an initialization method F11_{sig}, signature target adding method F12_{sig}, and signature statement generating method F13_{sig}.

When syntax analysis method F10_{sig} is executed by GUI display method F4_{GUI}, analysis method has a function for judging whether or not a signature template “t” is included in the XML document D delivered from data receiving method F1ₑₓₜ.

When initialization method F11_{sig} is executed by signature creation preparing method F5, initialization method has; a function for generating a structure of an XML signature S, generating an element of public key information s3 based on a Subject name of a public key certificate, and inserting the element into an XML signature S; and a function for inserting a signature target element into an XML signature S based on signature target information s1 described in a signature template “t”.

When signature target adding method F12 is executed by signature target adding method F6, adding method has a function for obtaining a summary value or a hash value of a signature target to be added, and additionally inserting target information s1ᵢ (“i” denotes an arbitrary number) that includes the summary value or hash value into an XML signature S.

When signature statement generating method F13_{sig} is executed by signature creating method F7_{GUI}, generating method has; a function for acquiring a secret key that corresponds to public key information, obtaining a signature value s2 of signature target information s1, and additionally inserting this signature value s2 into the XML signature S; a function for, in the case where the XML document S includes the signature template “t”, replacing a template portion with the XML signature S, as shown in M2ᵣᵤₙ of FIG. 4; and a function for adding the XML signature S that follows a root element of the XML document D, and enclosing the entirety with a <Signed XML>tag, as shown in M1 of FIG. 4.

The function 31 to 33 each correspond to an object class in actual software, and method F1 to F13 each correspond to a method of the object class.

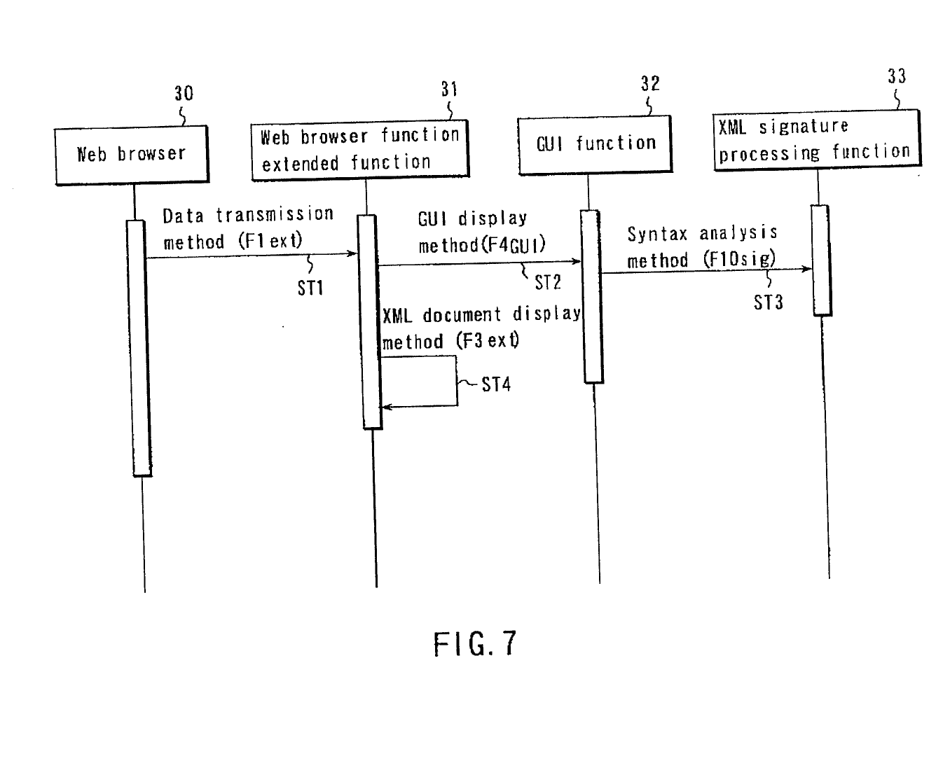

Now, an operation of an electronic signature system configured above will be described with reference to FIG. 7. FIG. 7 is a sequence diagram expressed by a UML (Unified Modeling Language) showing a flow of processing when a Web browser 30 receives XML data. In FIG. 7 the arrow indicates method when a function belonging to its root comprises a function indicated by a tip end, and indicates the flow of method executed in advance from the top to the bottom of the figure.

When a Web browser 30 receives data from an application, the browser judges whether or not data is an XML document D. In the case where the data is an XML document D, the browser executes a data receiving method F1ₑₓₜ of the Web browser function extended function 31 (ST1), and delivers an XML document D to the Web browser function extended function 31.

Data receiving method F1ₑₓₜ executes GUI display method F4_{GUI} of the GUT function 32 (ST2), and delivers an XML document D to the GUI function 32.

GUT display method F4_{GUI} executes syntax analysis method F10_{sig} of the ML signature processing function 33 (ST3), and checks whether or not a signature template “t” is included in the XML document D.

Next, GUT display method F4 GUT displays a screen for prompting an signer to instruct assignment of a signature over a Web browser 30.

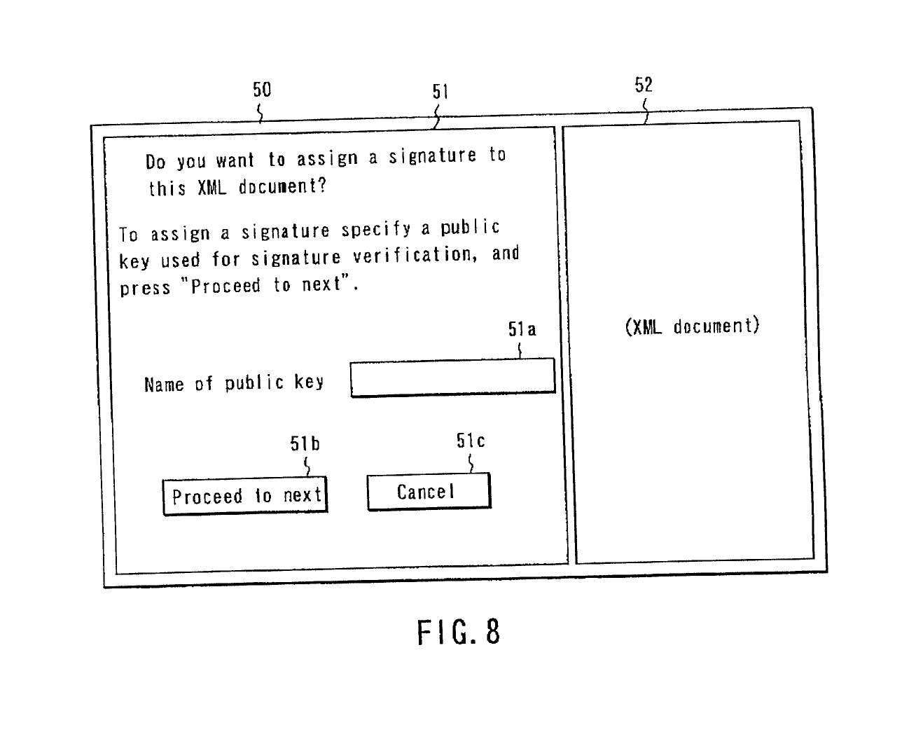

Then, a Web browser function extended function 31 execute XML document display method F3ₑₓₜ (ST4), newly generates a screen 52 for displaying the contents of the XML document D other than the screen 51 prompting an instruction for assigning a signature, as shown in FIG. 8, and displays a screen 50 together with these screens.

In the figure, although two screens 51 and 52 are displayed in parallel on one window screen 50 using a frame function of the Web browser 30, the screens 51 and 52 may be displayed on another window each other.

Here, the screen 51 prompting an instruction for assigning a signature displays: an input field 51a for specifying a public key certificate used for verification of a signature; a button 51 to be pressed when processing goes to next processing for making a signature; and a button 51c for exiting processing.

A Subject name or the like, for example, is inputted in the input field 51a. The input to the public key certificate is executed when a signature S of a person other than authorized person is inhibited. In this case, as an operational example, public key information (Subject name) s3 shown in FIG. 3 is described in advance, and it is verified whether or not the above information is equal to public key information (Subject name) inputted in FIG. 8. If they are different from each other, a warning is displayed, and processing is terminated.

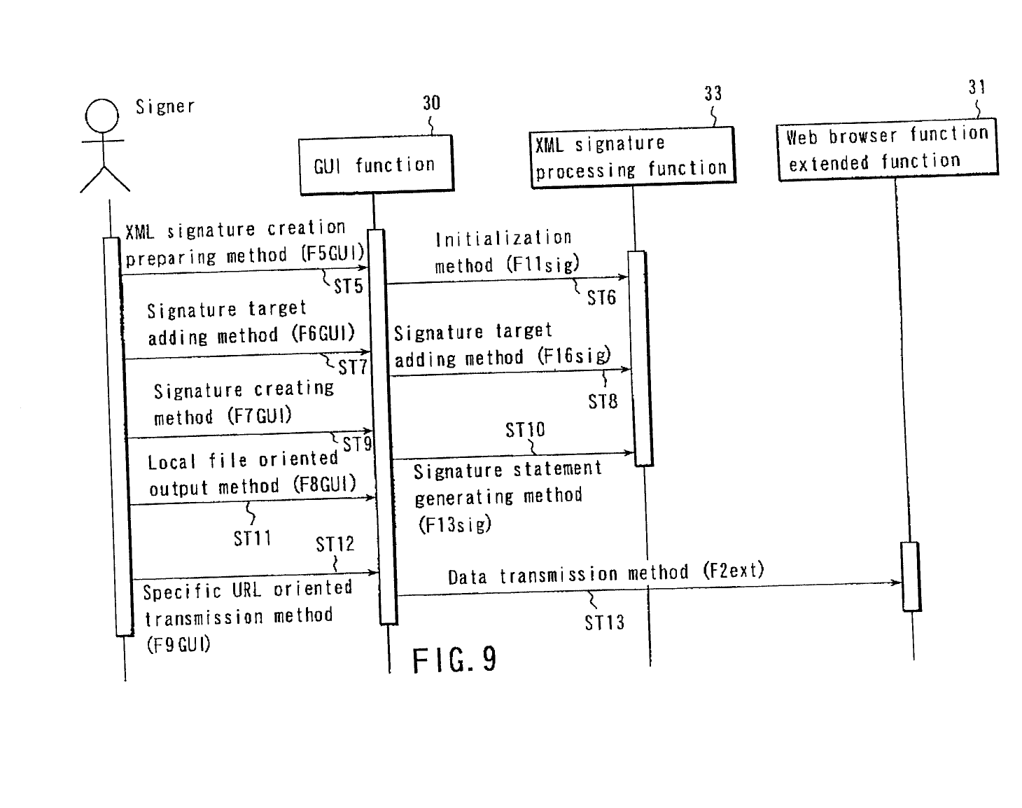

When a signer presses a button 51b, as shown in C1 of FIG. 6 and FIG. 9, signature creation preparing method F5_{GUI} is executed (ST5). At this time, the Subject name of the public key certificate inputted to the input field 51a is delivered to the GUI function 32.

The signature creation preparing method F5_{GUI} executes initialization method F11 of the XML signature processing function 33 (ST6). At this time, the Subject name of the public key certificate is delivered to the XML signature processing function 33.

The XML signature processing function 33 generates a structure of the XML signature S, generates an element of the public key information s3 shown in FIG. 3, and inserts the element into the XML signature S based on the Subject name. In the case where the XML document D includes the signature temperature “t”, a signature target element is inserted into the XML signature S based on the signature target information s1 described in the signature template “t”.

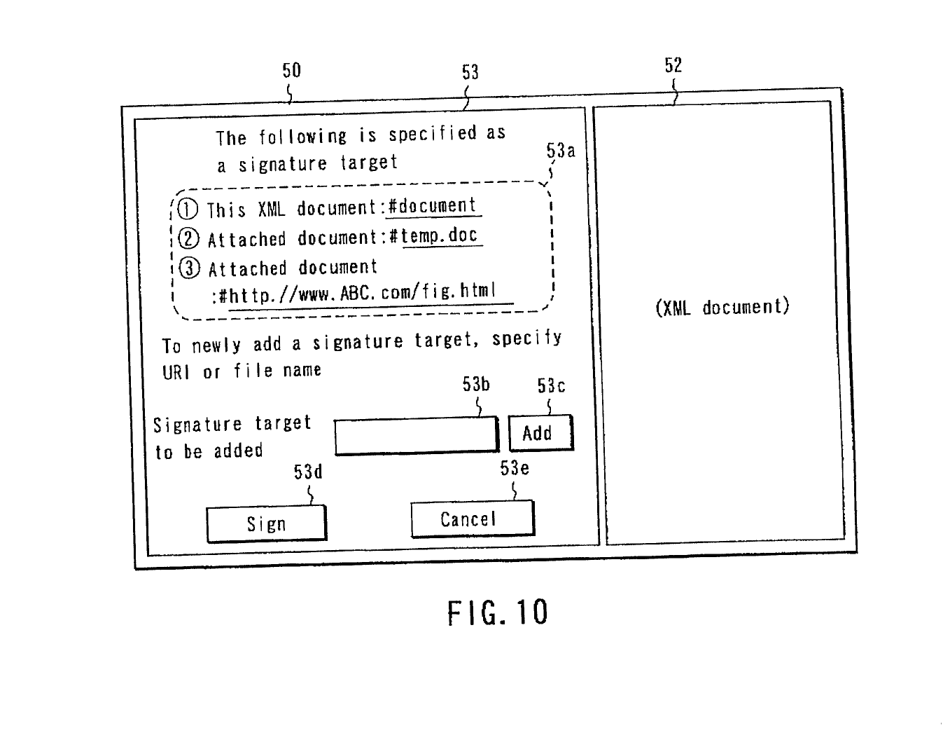

When the above processing terminates, the GUI function 32 displays a screen 53 for prompting a signer to add a signature target s1ᵢ, as shown in FIG. 10. As in FIG. 8, a screen 53 and a screen 52 for displaying the contents of an XML document D are displayed on a screen 50 of the Web browser 30. A current signature target list 53a is displayed on the screen 53.

In an example of this list 53a, an element \mathring{1} specified by an Id—“document” attribute of an original XML document, data \mathring{2} of a file name “temp.doc” locally placed, and a resource \mathring{3} over Internet specified by URL “http://www.ABC.com/fl.html” are specified.

In the case where a signature template “t” is included in the XML document D, the signature template “t” has information on a signature target “s1ᵢ” in the XML document D, and a signature target list 53a is displayed. In contrast, in the case where a signature template is included in the XML document D, the list 53a is provided as an empty field, and thus, it is required to manually add the signature target s1ᵢ.

When the signature target “s1ᵢ” is manually added, identification information (file name or URL) on a signature target is inputted to the signature target specification field 53b, and an addition button 53c is pressed (operation C2).

In this method, signature target adding method F6_{GUI} is executed (ST7). At this time, identification information inputted to the signature target specification field 53b is delivered to the GUI function 32. Signature target adding method F6_{GUI} reads the signature target s1ᵢ based on identification information on the signature target s1ᵢ, and executes signature target adding method F12_{sig} of the XML signature processing function 33 (ST8).

At this time, data on the read signature target s1ᵢ is delivered to the XML signature processing function 33 The XML signature processing function 33 obtains a hash value of data on the signature target s1ᵢ, and adds the signature target s1ᵢ to the XML signature S shown in FIG. 3.

When the above processing terminates, the GUI function 32 updates a screen shown in FIG. 10. After required signature target s1ᵢ has been added, the signer press a sign button 53d shown in FIG. 10 (operation C3). In the case where processing is cancelled, a cancel button 53e is pressed.

When the sign button 53d is pressed, signature creating method F7_{GUI} is executed (ST9). Signature creating method F7_{GUI} executes signature generating method F13_{sig} of the XML signature processing function 33 (ST10).

Signature generating method F13_{sig} acquires a secret key that corresponds to public key information, obtains a signature value “s2” of signature target information “s1”, and adds this signature value “s2” to an XML signature S. Then, in the case where the XML document D includes a signature template “t”, a template portion is replaced with the XML signature, as shown in M2ᵣᵤₙ of FIG. 4,

In addition, in the case where the above document does not include the signature template “t”, the XML signature S is added after the root element of the XML document, as shown in M1 of FIG. 4, and the entirety is enclosed in a <Signed XML>tag.

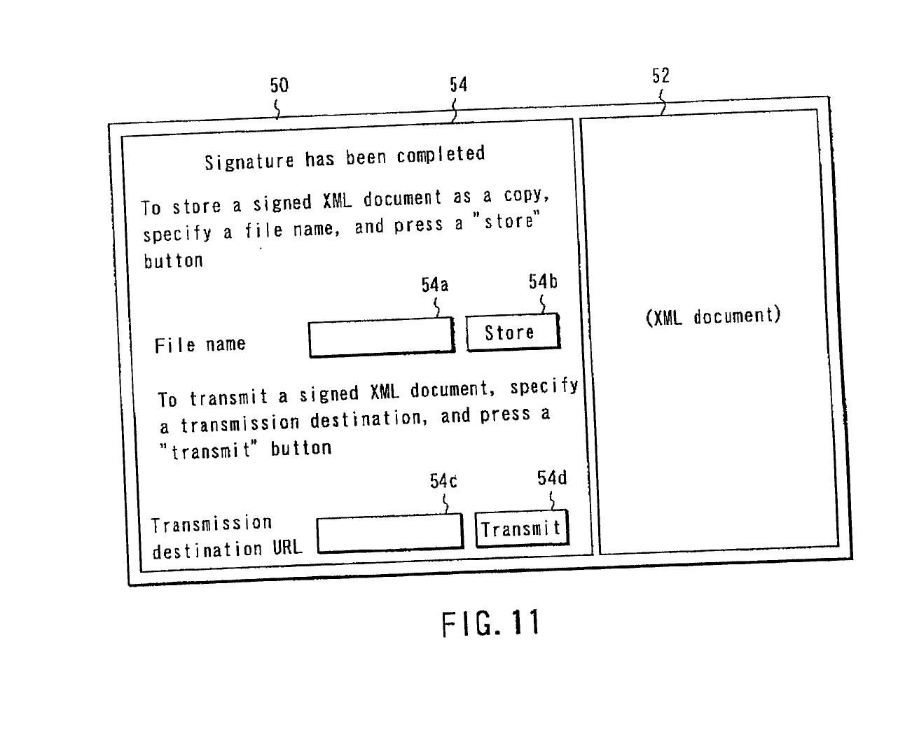

When the above processing terminates, a signature processing completion screen 54 is displayed, as shown in FIG. 11. In the case where the signed XML document is locally stared, a file name is inputted to an entry field 54a, and then, a store button 54b is pressed (operation C4). In this manner, local file oriented output method F8_{GUI} is executed, and the file name is delivered to a GUT function 32.

The GUT function 32 stores a signed XML document Ds by using this file name. To transmit the signed XML document Ds, a transmission destination URL is inputted to a URL specification field 54c, and a transmission button 54d is pressed (operation C5). In this manner, specific URL oriented transmission method F9_{GUI} is executed (ST12), and a transmission source URL is delivered to the GUT function 32.

Specific URL oriented transmission method F9_{GUI} executes data transmission method F2ₑₓₜ (ST13), and delivers the URL and signed XML document Ds to a Web browser function extended function 31.

The Web browser function extended function 31 transmits the signed XML document Ds to this URL by an “http” protocol or “https” protocol. In the case where a transmission destination URL is described in the XML document D in accordance with a specific format, such URL is displayed in advance in an URL specification field 54c, thereby an input process may be eliminated.

On the other hand, when a receiver's electronic signature device 20 receives a signed XML document Ds, the device displays a screen that includes an XML document D over a Web browser 40. In the case where the XML document D includes a signature S, the XML signature S is verified, and a screen including the signature verification result is displayed.

As has been described above, according to the present embodiment, an XML signature S can be assigned to the XML document created by arbitrary applications A1 to An over the Web browser 30, and convenience can be improved. In addition, the XML signature S can be verified.

Further, a signature function using a signature template “t” can be achieved, and convenience can be improve more. In addition, the signed XML document Ds can be managed as a local file. Furthermore, the signed XML document can be transmitted to a predetermined URL.

Still furthermore, when the XML signature template “t” includes a public key information “s3”, it is checked whether or not the public key information and the key information specified by the screen 51 coincide with each other. When they do not coincide, a warning is displayed, and processing is terminated. In this manner, an incorrect specification of key information can be inhibited

(Second Embodiment)

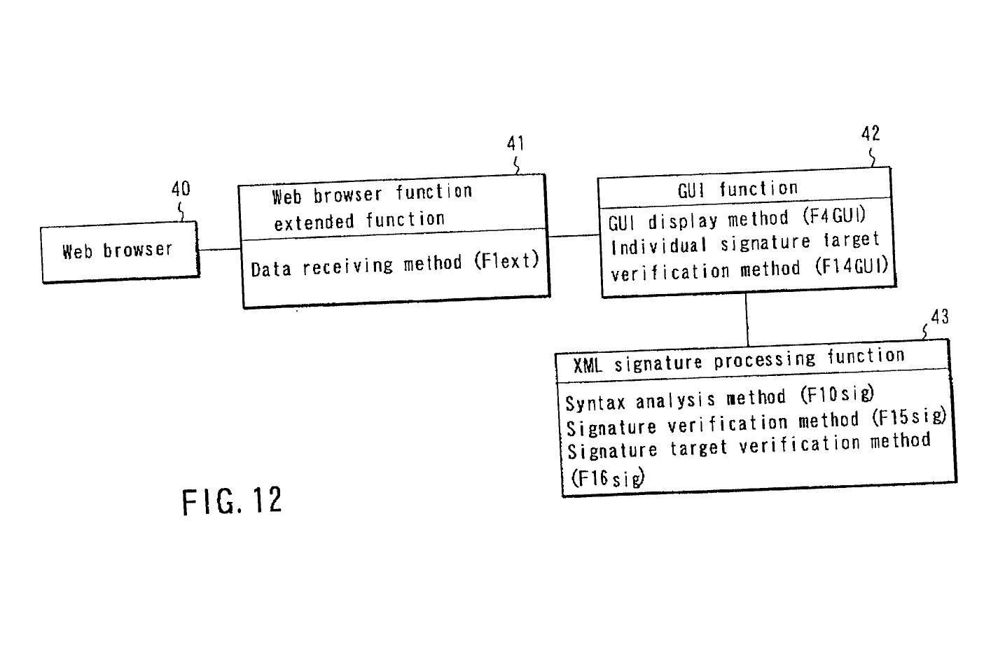

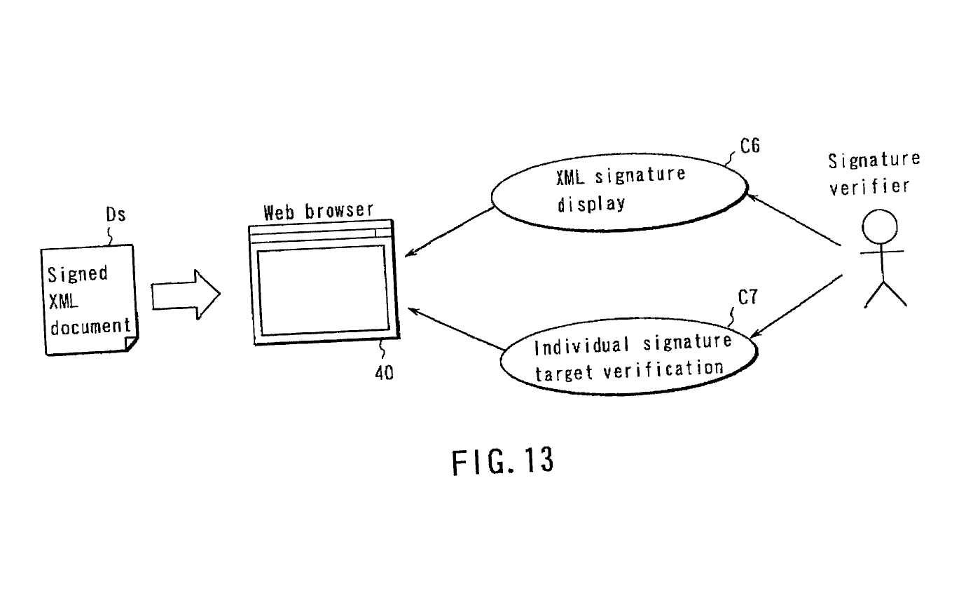

FIG. 12 is a schematic view showing a software structure for extending a Web browser function of an electronic signature device using a signature storage medium according to a second embodiment of the present invention. FIG. 13 is a schematic view showing an operation concerning signature verification to be carried out for this Web browser. Like elements shown in the previously described figures are designated by like reference numbers. A detailed description is omitted here. Here, only different elements will be described. In the following embodiment as well, a duplicated description is omitted here.

That is, the present embodiment describes a specific example concerning a signature verification function of a receiver's electronic signature device 20 in accordance with the first embodiment. As shown in FIG. 12, the Web browser function extended function 41, GUI function 42, and XML signature processing function 43 are extended over the Web browser 40. As shown in FIG. 13, an XML signature display operation C6 caused by a signature verifier or a verifying operation C7 for individual signature targets is executable for the signed XML document Ds read by the Web browser 40.

The XML signature display operation C6 is an operation for verifying its validity and displaying the verification result in the signed XML document Ds has been received. This operation is automatically executed when the Web browser 40 receives the XML document D.

Individual signature target verification C7 is an operation for specifying an external specification disable resource and verifying a signature for a signature target “s1ᵢ ” that cannot be verified for a signature by operation C6 because the signature target s1ᵢ in the XML signature S has referred to such external specification disable resource.

As in FIG. 6, a Web browser function extended function 41 is connected to the Web browser 40, and the function 41 is connected to a GUT function 42 and an XML signature processing function 43. That is, in the receiver's electronic signature device 20, a program for achieving each of the functions 41 to 43 has been installed in advance from a storage medium, whereby the function of the Web browser 30 is extended.

The Web browser function extended function 41 is similar to the previously described Web browser extended function 31.

In the Web browser 42, individual signature target verification method F14_{GUI} are added to the previously described functions F4_{GUI} to F9_{GUI}.

Individual signature target verification method F14_{GUI} are executed by operation C7, and has a function for reading a signature target based on manually specified address information, and then, executing signature target verification method F16_{sig} of an XML signature processing function 43.

In the XML signature processing function 43, signature verification method F15_{sig} and signature target verification method F16_{sig} are added to the previously described functions F10_{sig} to F13_{sig}.

Signature target verification method F16_{sig} is executed by individual signature target verification method F14_{GUI}, has a function for obtaining its hash value from data on read signature target s1ᵢ, verifying whether or not the obtained value is equal to a hash value (signature value “s2”) that corresponds to a signature target “s1” of an XML signature S, and returning the verification result to the GUI function 42.

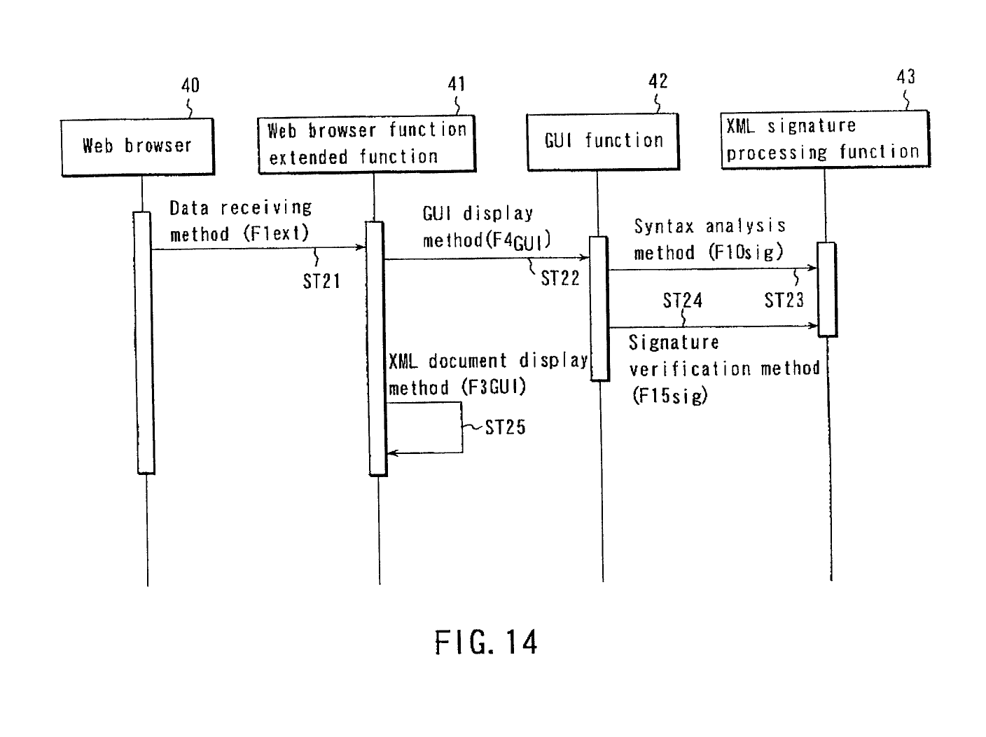

Now, a operation of an electronic signature system configured above will be described with reference to FIG. 14.

Assume that a creator's electronic signature device 10 transmits data, and a receiver's electronic, signature device 20 receives the data in the same manner as described previously.

When the Web browser 40 of the electronic signature device 20 has received data included in an XML document D, the browser executes data receiving method F1ₑₓₜ of the Web browser function extended function 41 (ST21). Then, the browser executes GUI display method F4_{GUI} of the GUI function 42 (ST22), executes syntax analysis method F10_{GUI} of the XML signature processing function 43 (ST23), and deliverers an XML document D to the XML document 43.

The XML signature processing function 43 syntax-analyzes a XML document D, checks whether the document includes a signature template “t” or includes an XML signature S, and returns the result. The signature template “t” is included in the case where a signature is assigned, and the subsequent processing is as described with reference to FIG. 7.

Here, in the case where the XML signature S is included, in order to verify a signature, the GUT function 42 executes signature verification method F15_{sig} of the XML signature processing function 43 in order to verify a signature (ST24).

Signature verification method F15_{sig} checks the content of the XML signature S, acquires a predetermined public key, and verifies signature target information “s1” and a signature value “s2”. When verification has been passed, individual signature targets “s1ᵢ” included in the signature target information s1 are verified.

When individual signature targets are verified, a signature target described in a signature target “s1ᵢ” of the XML signature S is read, and a hash value of the data is obtained. It is verified whether or not the obtained hash value is equal to the hash value (signature value s2) described in the signature target “s1ᵢ”.

There are three verification results, “OK”, “NG”, and “verification incomplete”. Among them “verification incomplete”, indicates that the signature target “s1” is not included in the XML document D, and that data cannot read by an external script file, In this case, data may be verified by manually specifying it afterward.

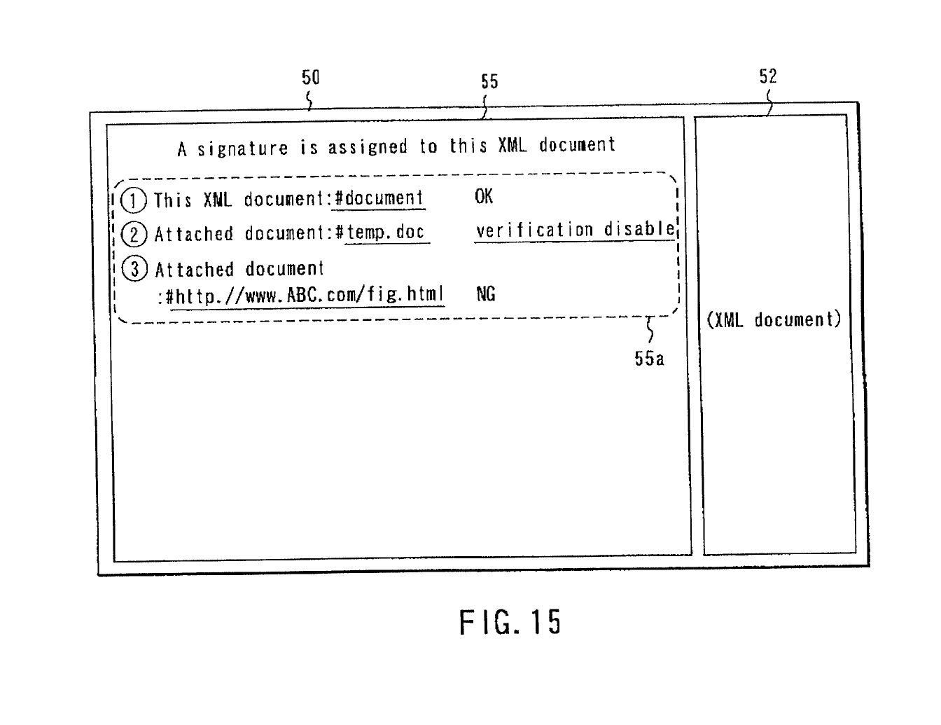

The verification results of the signature target information “s1” and individual signature target are returned to the GUI function 42 in an arranged manner. The GUI function 42 displays a signature verification result screen 55 indicating the verification results based on arrangement of the verification results, as shown in FIG. 15.

In addition, the Web browser function extended function 41 executes XML document display method F3_{GUI} (ST25), and displays a screen 52 indicating the contents of the XML document on the Web browser 40.

The signature verification result screen 55 displays a report that a signature is assigned to the XML document and a list 55a of signature verification results. A signature target name of the list 55a is a hyperlink, the signature target name is clicked by the mouse, whereby a Web browser screen for checking the contents of the signature target is initiated.

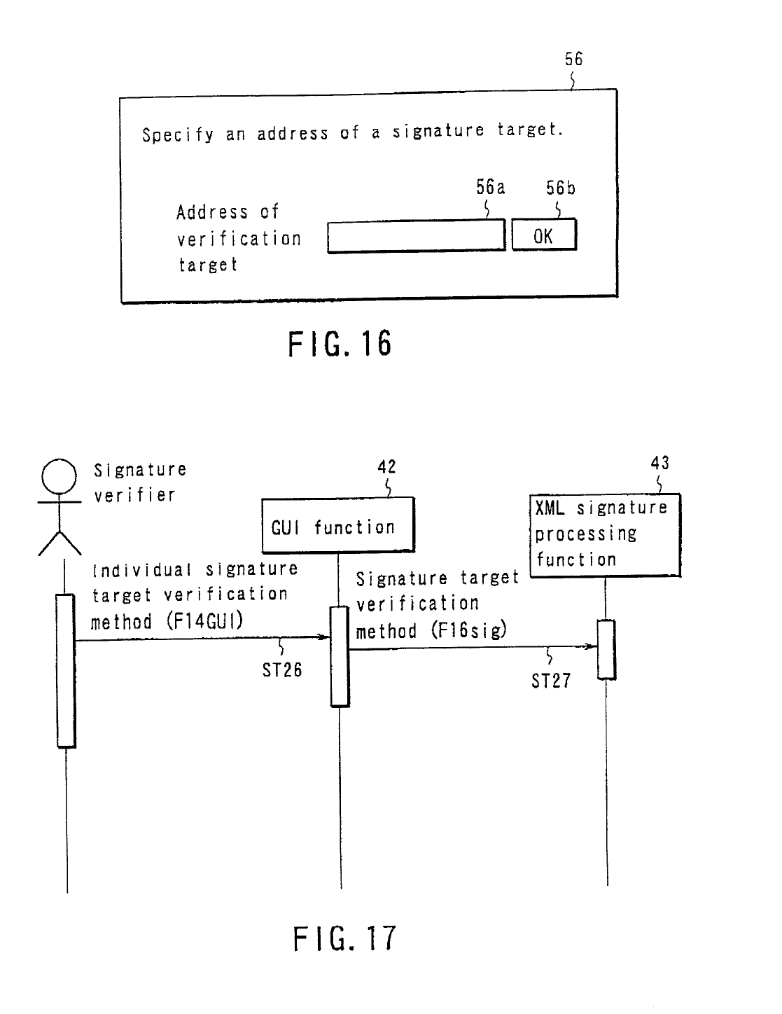

In addition, when a portion whose verification result is “verification incomplete” is clicked by the mouse a window screen 56 for specifying an address of a signature target is initiated, as shown in FIG. 16.

This window screen 56 specifies address information on a signature target. A file name or URL is inputted to an entry field 56a, and then, an OK button 56b is pressed. Otherwise, a cancel button may be provided.

When the OK button 56b is pressed (operation C7), individual signature target verification method F14_{GUI} of the GUI function 42 are executed, as shown in FIG. 17 (ST26).

Individual signature target verification method F14_{GUI} reads a signature target based on the address information specified in the entry field 56a, and then, signature target verification method F16_{sig} of the XML signature processing function 43 is executed (ST27).

At this time, data on the read signature target “s1ᵢ” is delivered. Then, the XML signature processing function 43 obtains a data hash value, checks whether or not the obtained value is equal to a hash value (signature value “s2”) that corresponds to a signature target “s1” of the XML signature S, and returns the result to a GUI function 42.

The GUI function 42 updates a list 55a of the signature verification result screen 55 based on the verification result. When a signed XML document Ds is stored as a local file, storing may be carried out by a function of the Web browser 30 on the screen verification result screen 55.

As has been described above, according to the present embodiment, in addition to the result of the first embodiment, an XML signature S of the XML document D can be verified over the Web browser 40 relevant to the XML document D processed by an arbitrary application, and convenience can be improved.

Although the present embodiment has described each of the screens 50 to 56 by exemplifying the screens shown in FIGS. 8, 10, 11, 15, and 16, the present embodiment can be modified and carried out as required as long as the illustrated information is suggested, and a function for inputting required information is provided.

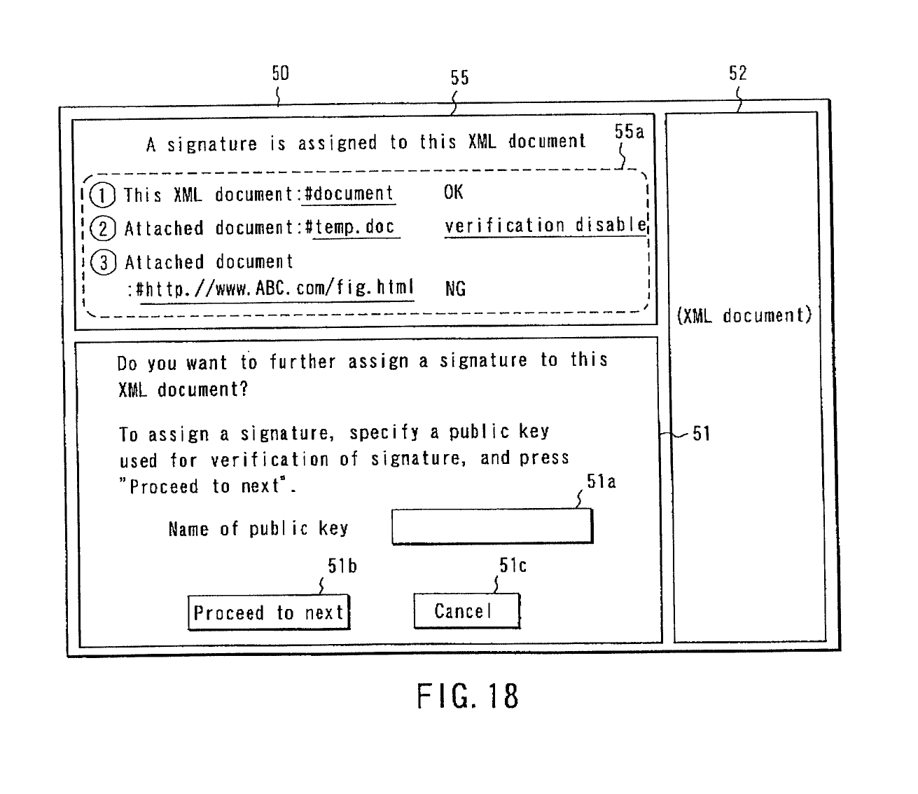

In addition, the present embodiment may be a system such that a multiply signed XML document on which a signature S is further assigned to a signed XML document Ds on which verification of a signature has been terminated is created. For example, this system is effective in multiply assigning signatures such as document creator's signature, manager's signature, or president's signature. In this case, instead of FIG. 15, as shown in FIG. 18, the signature verification result screen 50 and signature assignment screen 51 may be displayed at the same time.

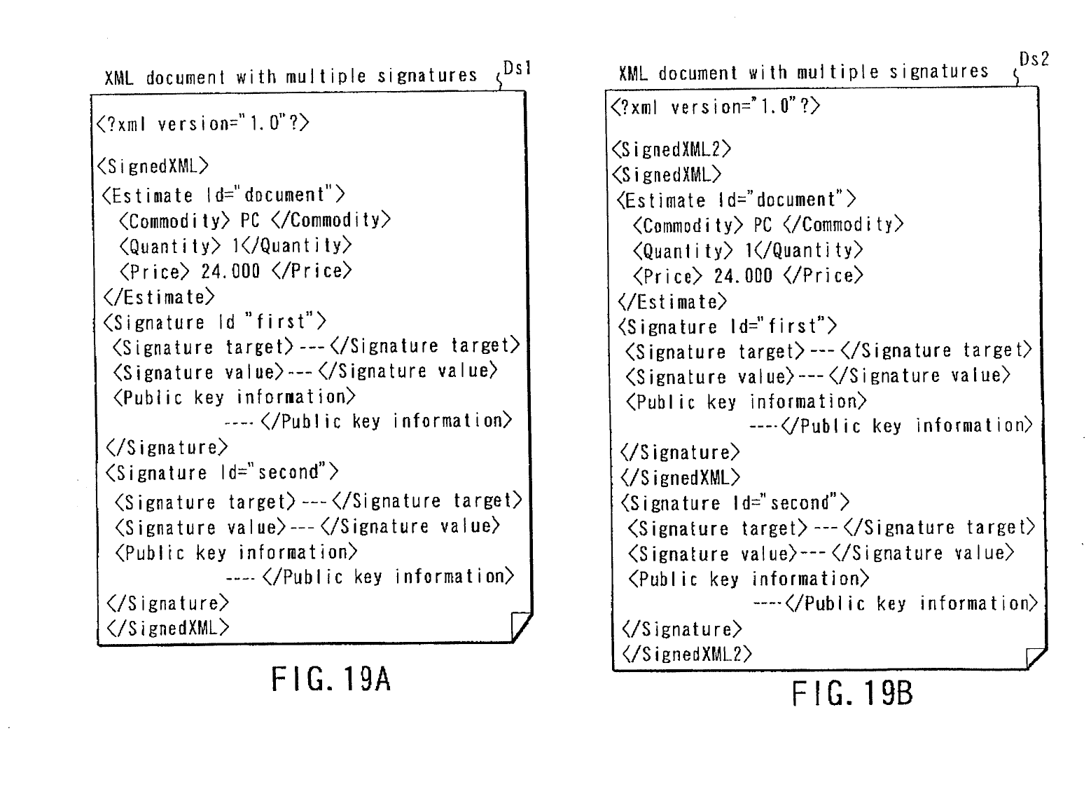

The signature assignment screen 51 is the same as that shown in FIG. 8, and operation for the screen 51 and subsequent operations are the same as those according to the first embodiment. In this case, in embedding the XML signature S in the XML document D, as in a multiply signed XML document Ds1 shown in FIG. 19A, a “Signature” that follows a first “Signature” element may be filled. As in a multiply signed XML document Ds2 shown in FIG. 19B, a “Signature” that follows a “Signed XML” element is filled, and the entirety may be enclosed in the “Signed XML 2” tag. Any other name of the tag may be assigned as long as such name is defined in advance.

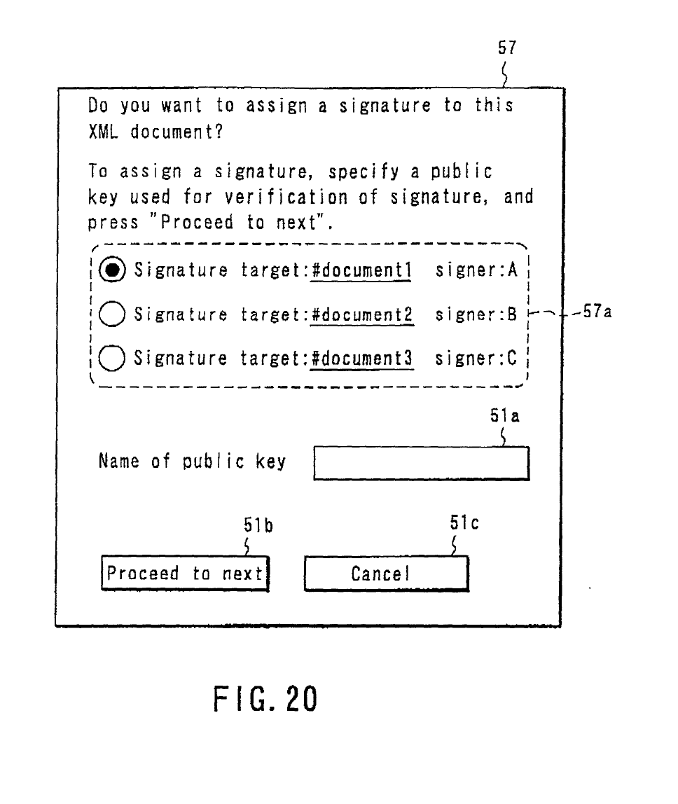

In addition, in a template “t” is assigned in advance to an XML document D when such multiple signatures are carried out, the screen 51 for assigning a signature shown in FIG. 8 or 18 is replaced with the screen 57 for assigning a signature shown in FIG. 20, whereby a signer can select a template “t” to be signed.

The screen 57 displays a radio button 57a for selecting a template, and selects a signature target. In the case where URL of the signature target “s1ᵢ” and template “t” include public key information, an identification name of a public key of a signer may be displayed. The operation and procedures after the template “t” has been selected are the same as those according to the first embodiment

(Third Embodiment)

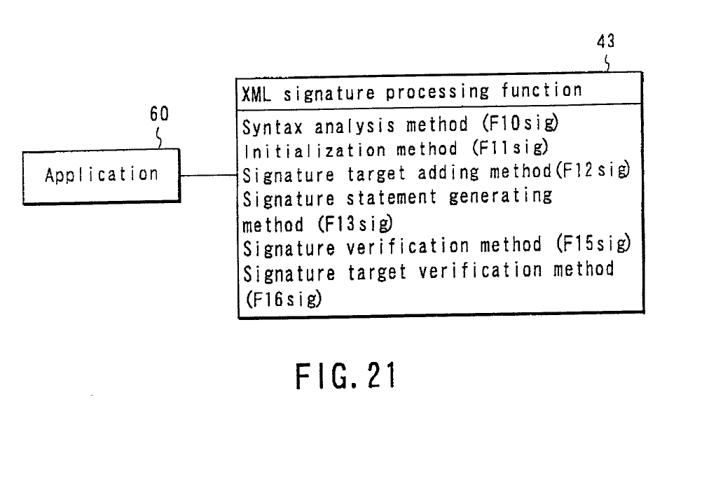

FIG. 21 is a schematic view showing a software structure for extending an application function for an electronic signature device using a signature storage medium according to a third embodiment of the present invention.

The present embodiment is a modified example of the second embodiment, where a signature of an XML document D is assigned/verified by a stand-alone application 60 instead of the Web browser 40.

Specifically an XML signature processing function 43 is connected to the application 60. That is, a program for achieving in advance a function 43 from a storage medium is installed in a computer, whereby a function of the application 60 is extended.

The XML signature processing function 43 comprises functions F10_{sig} to F16_{sig}, each of which is commonly connectable to a variety of applications. This function is different from those separately provided for each conventional application.

Here, a signature assignment sequence generates an XML document D by the application 60, and sequentially executes syntax analysis method F10_{sig}, initialization method F11_{sig}, signature target adding method F12_{sig}, and signature statement generating method F13_{sig}, thereby generating a signed XML document Ds.

On the other hand, when the application 60 has received a signed XML document Ds, a signature verification sequence sequentially executes syntax analysis method F10_{sig}, signature verification method F15_{sig}, and signature target verification method F6_{sig}, thereby verifying a signature.

With the above configuration, advantageous effect of the first and second embodiments can be provided for an arbitrary standalone application 60.

(Fourth Embodiment)

Now, a business model according to a fourth embodiment of the present invention will be described here. First, conventional general E-commerce will be described here.

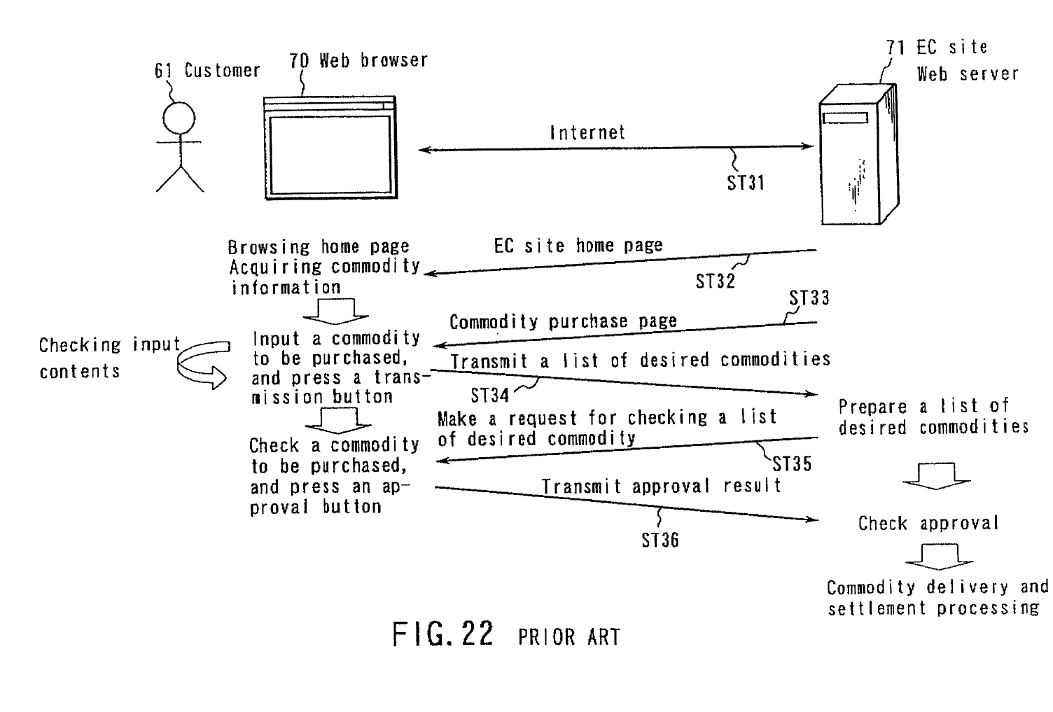

FIG. 22 shows a flow of procedures between a general customer and an EC (electronic commerce) site with respect to an example of service for purchasing commodities over Web in a B to C E-commerce. The procedures show establishment of purchase agreement. A description of the subsequent commodity delivery or settlement processing is omitted here because such processing is out of the scope of the present invention.

First, a customer 61 provides an access from its own Web browser 70 to a Web server 71 that is opening an EC site via Internet (ST31), and browses a home page at the EC site (STS2). Information concerning commodities is described on the home page, and a desired commodity is determined by such browsing, When the commodity is determined, in general, processing moves to a commodity purchase page for inputting customer information such as desired commodity number name, and address and specifying a settlement method or the like (ST33).

Then, the customer 61 enters required items, and presses a transmission (or equivalent) button. In the Web browser 70, a function such as JavaScript is generally filled in an entry page, it is checked whether or not the input contents are deficient. When the check is passed, the input contents are transmitted to the Web server 71 of the EC site (ST34).

The Web server 71 delivers a document describing a list of desired commodities based on the input contents in an “html” form to the Web browser 70, and makes a request for check of the contents (ST35).

The customer 61 checks the contents of a purchase application displayed on the Web browser 70, and presses an approval (or equivalent) button if the check result is correct. When the approval button is pressed, approval information is delivered to the Web server 71, and control is moved to procedure for commodity delivery and settlement.

In such trade mode shown in FIG. 22, the following is requested from the viewpoint of safety.

1. Authentication that an EC site is valid from the standpoint of customer

2. Safe data exchange and prevention of interpolation over Internet

3. Certificate of the fact of customer's purchase application from the standpoint or the SC site

4. Certificate of the fact of purchase application from the standpoint of the customer

Here, the requests 1 and 2 can be satisfied by a technique such as SSL (Secure Socket Layer), and are carried out at many sites.

On the other hand, the requests 3 and 4, in fact, are not carried out yet.

Now, a fourth embodiment of the present invention considering the above contents will be described here. In the present embodiment, function extension software capable of assigning/verifying a signature corresponding to an XML and XML-Signature is used over a Web browser, thereby satisfying the requests 3 and 4. The function extension software comprises a function identical to that described in the first or second embodiment.

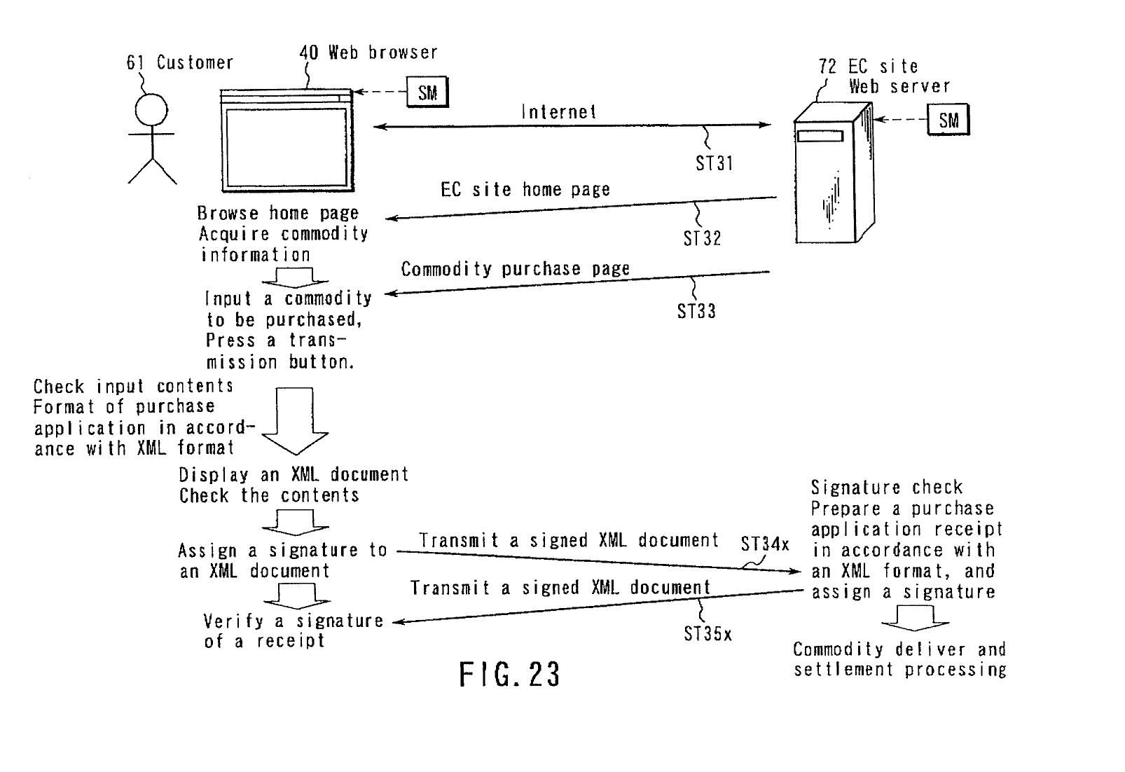

FIG. 23 is a schematic view showing a process for E-commerce applied to a business method according to the fourth embodiment of the present invention, This E-commerce system is configured such that both of the Web browser 40 of the customer 61 and the Web server 72 of the shop each have a function for assigning/verifying a signature of the XML document. That is, in a computer for executing the Web browser 40 and a computer of the Web server 72, a program for achieving a function for assigning/verifying a signature from a (signature) storage medium SM in advance is installed and is operable.

FIG. 23 is the same as FIG. 22 in procedures for inputting commodities to be purchased by the customer 61 on a commodity purchase phase or any other customer information, following the step ST33. After input, when a transmission button is pressed by the customer 61, the Web browser 40 checks the inputted information, and further, generates an XML document D in accordance with a predetermined format.

In this XML document D, as described previously, the presence or absence of a signature template “t” is arbitrary, and the presence of the template “t” can simplify an operation of the customer 61. A transmission destination URL of the signed XML document Ds may be entered in the XML document D in accordance with a specific format.

The generated XML document D can be displayed over another Web browser. These processes can be easily achieved by a function such a JavaScript. The Web browser 40 having received the XML document D displays a signature assignment screen 51 shown in FIG. 8 in the same way as described previously, and prompts the customer 61 to assign a signature S.

Then, processing is advanced in accordance with an instruction from the screen 51, and a signed purchase application in the XML format (signed XML document Ds) is delivered to the Web server 72 at the EC site by an operation for pressing the transmission button 54d shown in FIG. 11 (ST34x). As in the first embodiment, a signed purchase application may be stored as the customer's local file.

When the Web server 72 at the EC site has received a signed purchase application, the application verifies a signature S by the XML signature processing function 43 in the same way as in the third embodiment.

When the signature S is valid, a purchase application receipt notifying receipt of a purchase application is prepared in an XML format, and a signature is assigned by application in the same way as in the third embodiment. This signed receipt is returned to the Web browser 40 of the customer 61 (ST35x).

The Web browser 40 verifies an indication and a signature of the receipt (XML document D) in the same way as in the second embodiment.

Although preparation and return of the signed receipt may be eliminated, returning the signed receipt to the customer 61 makes it possible to obtain reliability of the customer 61, and improve the repetition rate at which the customer 61 makes a purchase again at the same EC site.

As described above, according to the present embodiment, in addition to advantageous effects of the first and second embodiments, an XML signature S can be assigned over the Web browser 40 relevant to the XML document D prepared by a arbitrary application concerning businesses, and convenience or reliability can be improved. In addition, the similar improvement in convenience or reliability can be achieved according to the contents of such arbitrary application.

Although the present embodiment exemplifies a B to C E-commerce, for example, a Web-based B to B transaction or electronic application and electronic procurement is basically identical in that an electronic signature S is applied to the XML document D over the client's Web browser 40 without being limited thereto. Thus, the similar advantageous effect can be achieved by carrying out the present invention.

In order to assign/verify a signature over the Web browser 40, although such assignment and verification can be performed by software comprising functions 41 to 43 described in the second embodiment, for example, another means may be a method for initiating an applet that comprises a function for assigning/verifying a signature over the Web browser 40.

In addition, the customer's public key used for a signature S may be delivered by using a PKI (public key infrastructure) or may be delivered in advance by providing membership in the EC site.

(Fifth Embodiment)

Now, a fifth embodiment of the present invention will be described here. First, the technical background of the present embodiment will be described. In recent years, with introduction to ASP (application service provider), a business model for outsourcing system construction, operation, and maintenance becomes more popular.

In the ASP, in general, transaction processing is executed by the ASP server unit, and only operation or display is made over a Web browser.

On the other hand, an electronic signature instead of a company signature is assigned to a document exchanged in B to B trading in accordance with the fact that a legal force for an electronic signature is explicitly stated. In addition, it is considered that an electrical signature is generally assigned to an application document or a decision document in an enterprise system.

Alternatively, in the ASP, all data processing is executed over the ASP's server unit, and currently, assignment/verification of a signature, of course, is currently carried out at the ASP.

However, in principle, a secret key used to assign a signature is managed by a signer, It is required for the client to assign a signature.

Now, a fifth embodiment of the present invention considering the above contents will be described here.

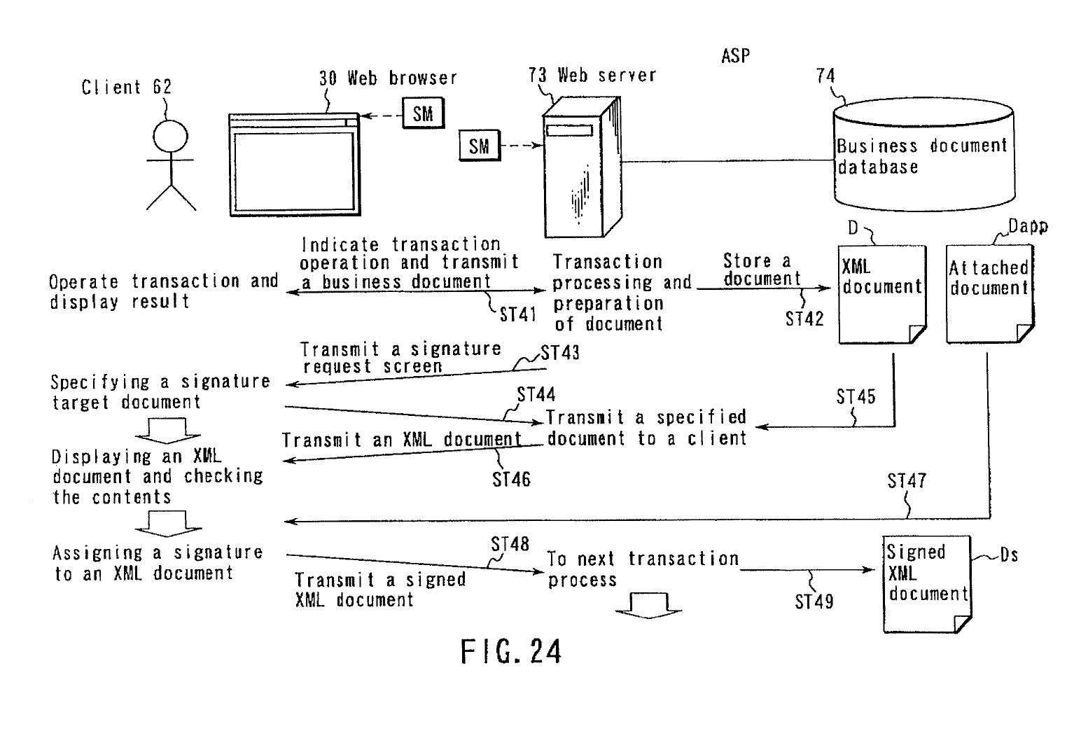

FIG. 24 is a schematic view showing a process applied to an ASP service business method according to the fifth embodiment of the present invention. In the same figure, a client 62 is a member of the client, company or organization utilizing ASP service.

The Web browser 30 of the client 62 has a function for making communication with an ASP Web server 73, and displaying an instruction for business operation or an XML document D created as a result of the instruction and a function for specifying an XML document D targeted for signature for the ASP Web server 73, displaying the obtained XML document D, and assigning the signature S.

The businesses include preparation of a decision document, preparation of an enterprise application, settlement of travel cost, and preparation of an estimate or order sheet and the like.

The ASP Web server 73 is connected to a business document database 74. This server has a function for carrying out transaction processing and preparation of the XML document D by an instruction from the Web browser 20 and a function for storing/managing the prepared XML document D in the business document database 74.

Although the XML document D is arbitrary as to whether or not the signature template “t” is present similarly as described previously, the presence of the template “t” can simplify an operation of the client 62. A return destination URL of the signed XML document Ds may be described in the XML document Ds in accordance with a specific format.

In addition, in the same way as described previously, in a computer for executing the Web browser 30 and a computer of the Web server 72, a program for achieving a function for assigning/verifying a signature from a (signature) storage medium SM is installed in advance, and is operable.

Now, an operation of the ASP service configured above will be described here.

The Web browser 30 of the client 62 makes communication with the ASP Web server 73 (ST41), and assigns an instruction for transaction operation to the Web server 73.

The ASP Web server 73 carries out transaction processing based on this instruction, and returns the created XML document D to the Web browser 30 of the client 62.

The Web browser 30 of the client 62 displays the returned XML document D, and assigns an instruction for storage or the like to the ASP Web server in accordance with an operation of the client 62 as required.

The ASP Web server 73 stores the XML document D in a business document database 74 in accordance with a storage instruction (ST42).

In this manner, the preparation and storage of the XML document D by the ASP service are completed.

Next the Web browser 30 of the client 62 applies a signature to the XML document D created by the ASP Web server 73, and thus, transmits a request for transmitting a signature request screen to the ASP Web server 73.

The ASP Web server 73 having received this transmission request transmits the signature request screen to the Web browser 30 (ST43).

When the Web browser 73 of the client 62 displays the signature request screen, a predetermined XML document D is specified on the signature request screen. When the transmission button is pressed, the contents of document specification is transmitted to the ASP Web server 73 (ST44)

The Web server 73 reads out the specified XML document D from the business document database 74 (ST45), and transmits this XML document D to the Web browser 30 of the client 62 (ST46).

The Web browser 40 having received the XML document D displays screens 50 to 52 shown in FIG. 8 in the same way as described previously, and prompts the client 62 to assign the signature S. A signature may be requested on page for creating a business document without using the signature request screen.

The client 62 can add an attached document on the screen 53 shown in FIG. 10 upon assignment of a signature. In this case, a attached document D app on the business document database is specified by URL, whereby the attached document D app can be downloaded via the Web server 73 (ST47) and can be attached to the signature S.

The Web browser 30 transmits to URL specified by the Web server 73 the signed XML document Ds on which assignment of a signature has been finally completed (ST48)

This signed XML document Ds is stored in the business document database 74 by the Web server 73 (ST49), and is moved to a next transaction process.

As has been described above, according to the present embodiment, in the client 62 utilizing ASP service, the XML signature S can be assigned over the Web browser 30 relevant to the XML document D created by an arbitrary application, and convenience can be improved.

In addition, the Web browser function is extended, thereby enabling a function for assigning/verifying a signature relevant to an XML document D over the Web browser 30. Thus, a secret key is safely operated under the control of the client 62, and further, ASP service with high reliability enabling assignment of a signature to a document can be achieved.

Further, the Web server 73 transmits the specified XML document to the client on the signature request screen, and displays a screen prompting selection of an XML document targeted for signature on the Web browser 40. In this way, at the server, the XML document targeted for signature can be provided relevant to the XML document under management in accordance with a signature request from the client, and convenience can be improved.

Although the present embodiment has described using software that comprises the functions 31 to 33 described in the first embodiment when a signature is assigned over the Web browser 30, another means having equivalent functions may be provided without being limited thereto. Such another means may be provided as a method for initiating an applet that comprises a function for assigning a signature over the Web browser 30 or the Web browser itself may comprises similar functions.

In addition, a public key used for the signature S may be delivered/operated in associated organization or ASP may provide PKI service. In addition, this public key may be a public key for company managed by Ministry of Legal Affairs or private PKI service may be utilized.

Although the present embodiment has described assignment of a signature by the client 62, a signature may be verified over the Web server 73 by a method similar to that according to the third embodiment of the present invention, and the result may be displayed on the Web browser 30 of the client 62. As shown in the second embodiment, the XML document D targeted for verification is delivered to the Web browser 40 of the client 62, whereby verification of a signature and display of the verification result may be carried out over the Web browser 40.

(Sixth Embodiment)

Now, a sixth embodiment of the present invention will be described here. In the present embodiment, a signature is assigned at the server unit relevant to the XML document Dt with the signature template transmitted from the client's device, and the obtained XML document with the signature Ds is returned to the client's device.

This mode is applicable to a case where, for example, people (client) submits an application document, the XML document with the signature template Dt to an administrative department and agency (server), and receives the XML signature of the administrative department and agency.

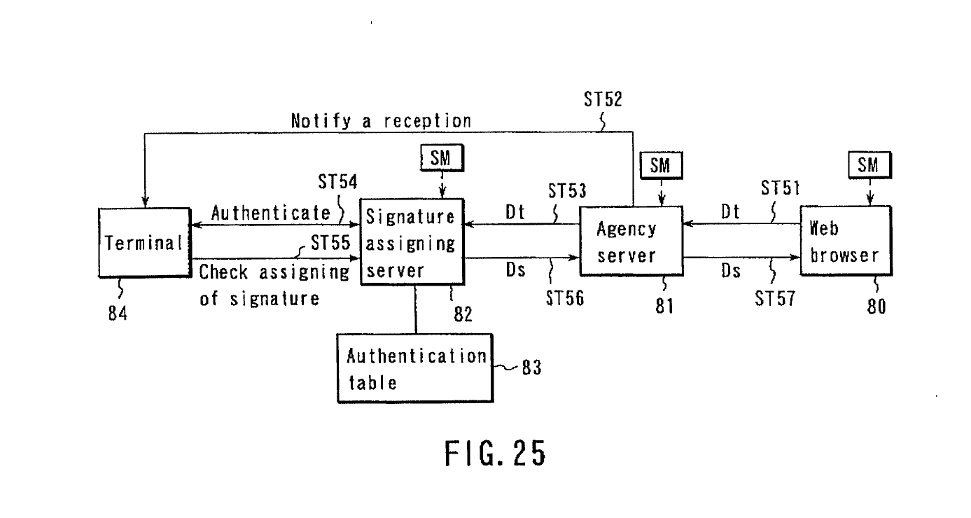

FIG. 25 is a schematic view showing a configuration of a signature assignment system applied to a business method according to the sixth embodiment of the present invention. This signature assignment system comprises an Web browser 80, a server's agency server 81, a signature assigning server 82, an authentication table 83, and a terminal 84. In the same way as described previously in a computer for executing the Web browser 80 and a computer of each of the servers 81 and 82, a program for achieving functions each concerning a signature from a (signature) storage medium SM is installed in advance, and is operable.

Here, the Web browser 80 belongs to the client's computer and is connected to the agency server 81 via a network. The Web browser 80 has a function for submits an application document to the agency server 81.

The agency server 81 has the following functions (f81-1) to (f81-4):

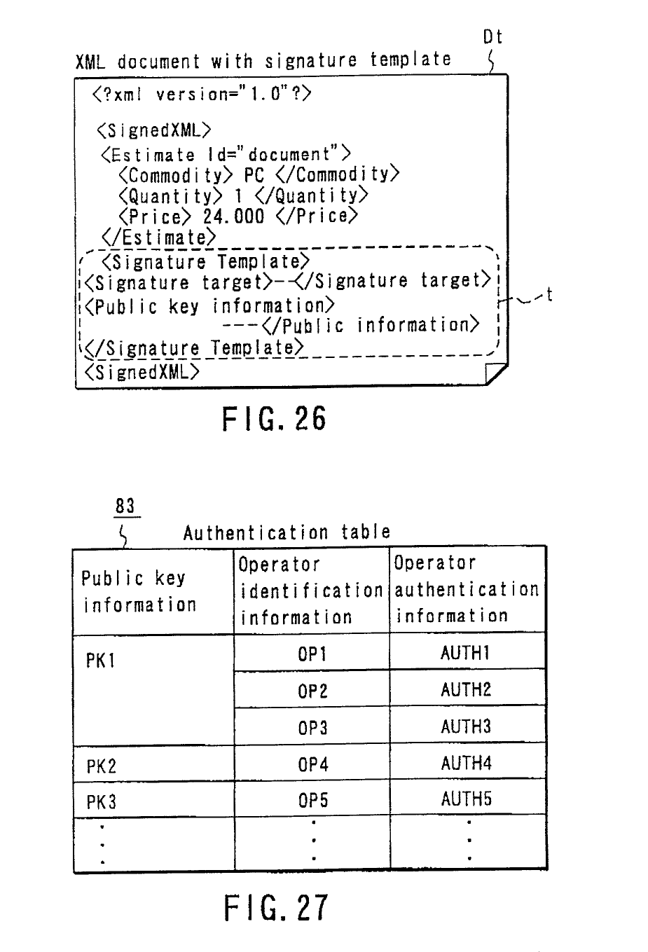

(f81-1) a function for, when an application document is received from the Web browser 80, generating the XML document with the signature template Dt, as shown in FIG. 26, based on the submitted an application document;

(f81-2) a function for transmitting notification of reception prompting assignment of a signature based on the contents of the XML document with the signature template Dt;

(f81-3) a function for transmitting the XML document with the signature template Dt to the is signature assigning server 82; and

(f81-4) a function for returning the XML document with the signature Ds received from the signature assigning server 82 to the Web browser 80.

The function for transmitting notification of reception may be achieved by e-mail or the like. This function is achieved by registering in advance a correspondences between the types of the XML document with the signature template Dt (for example, document ID and/or public key information) and an e-mail address of the terminal.

The signature assigning server 8 has the following functions (f82-1) to (f82-3):

(f82-1) a function for storing the XML document with the signature template Dt received from the agency server 81;

(f82-2) a function for, when an access from the terminal 84 is authenticated by the authentication table 83, and the authentication result shows validity, analyzing the corresponding XML document with the signature template Dt based on an instruction from the terminal 84, assigning a signature based on information on the signature template “t”, and creating the signed XML document Ds; and

(f82-3) a function for transmitting the obtained, signed XML document Ds to the agency server 81.

The agency server 81 and the signature assigning server 82 may be integrally provided as one server unit.

The authentication table 83 can read out data from the signature assigning server 82. As shown in FIG. 27, a correspondences or operator identification information OP1, . . . , operator authentication information AUTH1, . . . and public key information PK1, . . . are registered. As operator authentication information AUTH1, . . . , arbitrary passwords or physiological identification information and the like can be used.

Now, an operation of a signature assigning system configured above will be described here.

The Web browser 80 submits the application document to the agency server 81 by the client's operation (ST51).

The agency server 81 having received application document, generates XML document with signature template Dt then transmits the notification of reception to the terminal 84 based on the contents of the XML document with the signature template Dt (ST52), and transmits the XML document with the signature template Dt to the signature assigning server 82 (ST53)

The signature assigning server 81 stores the XML document with the signature template Dt received from the agency server 81.

The terminal 84 displays the notification of reception received from the agency server 81, and prompts the operator to provide an access.

The signature assigning server 82 authenticates an access from the terminal 84 by referring to the authentication table 83 (ST54). When the authentication results shows validity, the corresponding XML document with the signature template Dt is transmitted to the terminal 84.

The terminal 84 displays the XML document with the signature template Dt together with a check icon (not shown), and prompts the operator to check the assignment of a signature.

Here, the operator selects a check icon (ST55). Public key information is included in the XML document with the signature template in advance. Thus, there is no need for operation for specifying public key information.

The signature assigning server 82 assigns a signature to the corresponding XML document with the signature template Dt based on an operation for selecting a check icon, and creates the signed XML document Ds.

In addition, the signature assigning server 82 transmits the created, signed XML document Ds to the agency server 81 (ST56).

The agency server 81 returns the signed XML document Ds to the Web browser 80 (ST57).

The Web browser 80 verifies a signature of the transmitted, signed XML document Ds. When the verification result is valid, the signed XML document Ds is stored in a storage device (not shown).

As has been described above, according to the present embodiment, there can be provided an arbitrary processing system for assigning an XML signature to the server, and returning the obtained XML document Ds to the client.

In addition, the signature template “t” includes public key information. Thus, there is no need to specify public key information when a signature is assigned. Therefore, in the signature assigning server 82, a signature can be assigned merely by receiving check for assigning the signature.

Means for applying the XML document with the signature template Dt to the signature assigning server 82 (hereinafter, referred to as application function) may not always be composed of the Web browser 80 and the agency server 81. That is, application function may be a function for transmitting the XML document with the signature template Dt to the signature assigning server 82, a function for receiving the signed XML document Ds, and a function for delivering the notification of reception to the terminal 84.

Such application function can be provided by an arbitrary application as long as the function contains a function for carrying out a series of document processing, for example, and a function for, when it is required to assign a signature, assigning a signature template “t” to an XML document D, and transmitting the obtained XML document with the signature template Dt to the signature assigning server 82.

In addition, according to the present embodiment, there is provided an advantage that a secret key used for a signature can be safely managed in a signature assigning server 82 as compared with a mode in which a signature is assigned over the Web browser according to the previously described embodiments. Further, there is provided an advantage that a plurality of authorized persons can use the same signature.

Here, the storage medium according to the present invention may include a magnetic disk, a floppy disk (registered trademark) disk, a hard disk, an optical disk (CD-ROM, CD-R, DVD or the like), magneto-optical disk (such as MO), a semiconductor memory or any kind of storage medium as long as the medium can store a program and can be a computer readable storage medium.

In addition an OS (operating system) operating on a computer based on an instruction from a program installed from a storage medium to a computer or MW (middleware) such as database management software or network software may execute a part of processes for achieving the present embodiment.

Further, the storage medium includes a storage medium for storing or temporarily storing a program transmitted via LAN or Internet and the like by downloading it with being limited to a medium independent of a computer.

Furthermore, the storage medium may not be one, may be included in storage media according to the present invention in the case where processing according to the present embodiment is executed from a plurality of media, and may be in any configuration.

The computer according to the present invention executes processes according to the present embodiment based on a program stored in a storage medium, and may be in a configuration of a system in which one device such as personal computer or a plurality of devices are connected via a network.

In addition, the computer according to the present invention includes a personal computer, a computation processing unit included in an information processing device, or micro-computer and the like, and is generally referred to as a device or unit capable of achieving a function of the present invention by a program.

The present invention is not limited to the above described embodiments, and can be variously modified within departing from the spirit of the invention at a stage of implementation. In addition, the embodiments each may be carried out by combining them to its required minimum. In this case the combined advantageous effects can be achieved. Further, the above embodiments each include inventions at a variety of stages, and a variety of inventions can be excerpted by properly combining a plurality of constituent elements. For example, in the case where some constituent elements are eliminated from all the constituent elements shown in embodiments, for example, whereby the invention is excerpted, when such excerpted invention is carried out, such eliminated portion is properly compensated for by well known technique.

Otherwise, the present invention can be carried out by variously modifying it without departing from the spirit of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A computer program product used for a computer capable of executing a Web browser, the computer program product comprising:
a storage medium readable from the computer; and
a signature program code stored in the storage medium, the signature program code achieving an XML signature function over the Web browser.

2. A computer program product according to claim 1, the signature program code comprises:
a first program code for displaying a screen for prompting the assigning signature;
a second program code for displaying a screen for specifying key information used for generating the XML signature;
a third program code for displaying a screen for adding a index of signature targets to the XML signature;
a fourth program code for, when the XML signature is instructed, using the specified key information, thereby obtaining a summary value targeted for the specified signature, and generating the XML signature that includes the summary value; and
a fifth program code for embedding the XML signature to the XML document and generating a signed XML document.

3. A computer program product according to claim 2, wherein the signature program code comprises:
a sixth program code for syntax-analyzing an XML document received over the Web program; and
a seventh program code for, when the XML document includes an XML signature template as a result of the syntax analysis, displaying a screen for displaying and verifying the contents of the template.

4. A computer program product according to claim 3, wherein the template includes signature target information for specifying a signature target and signer's public key information.

5. A computer program product according to claim 3, wherein the signature program code comprises:
an eighth program code for, when the XML signature template includes signer's public key information, checking whether or not the public key information and key information inputted on a screen for specifying the key information are coincident with each other; and
a ninth program code fort, when they are not coincident as a result of the check, carrying out indicating for a warning and/or cancellation of processing.

6. A computer program product according to claim 5, wherein the signature program code comprises:
a tenth program code for displaying a screen for inquiring whether or not the signed XML document is stored as a local file; and
a eleventh program code for storing the signed XML document in the computer by the specified file name.

7. A computer program product according to claim 6, wherein the signature program code comprises:
a twelfth program code for displaying a screen for inquiring whether or not the signed XML document is transmitted to a predetermined URL; and
a thirteenth program code for transmitting the signed XML document to the predetermined URL in accordance with the inquiry result.

8. A computer program product according to claim 2, wherein the signature program code comprises:
a tenth program code for displaying a screen for inquiring whether or not the signed XML document is stored as a local file; and
a eleventh program code for storing the signed XML document in the computer by the specified file name.

9. A computer program product according to claim 8, wherein the signature program code comprises:
a twelfth program code for displaying a screen for inquiring whether or not the signed XML document is transmitted to a predetermined URL; and
a thirteenth program code for transmitting the signed XML document to the predetermined URL in accordance with the inquiry result.

10. A computer program product according to claim 2, wherein the signature program code comprises:
a tenth program code for displaying a screen for inquiring whether or not the signed XML document is stored as a local file; and
a eleventh program code for storing the signed XML document in the computer by the specified file name.

11. A computer program product according to claim 10, wherein the signature program code comprises:
a twelfth program code for displaying a screen for inquiring whether or not the signed XML document is transmitted to a predetermined URL; and
a thirteenth program code for transmitting the signed XML document to the predetermined URL in accordance with the inquiry result.

12. A computer program product used for a computer capable of executing a Web browser, the computer program product comprising:
a storage medium readable from the computer; and
a verification program code stored in the storage medium, the signature program code achieving an XML signature verification function over the Web browser.

13. A computer program product according to claim 12, wherein the verification program code comprises:
a first program code for, when an XML document received over the Web browser includes an XML document, displaying the contents of the XML document, verifying the XML signature, and displaying the verification result;
a second program code for, when the verification is carried out, displaying the fact that signature verification is invalid if a verification process of target is incomplete;
a third program code for displaying a screen for specifying an address of a signature target to a target of the signature verification incomplete; and
a fourth program code for, when the address is specified, read the specified signature target, verifying the XML signature, and displaying the verification result.

14. A computer program product used for a computer capable of executing an application having an XML document creating function, comprising a computer readable storage medium having stored therein a program for applying an XML document to the created XML document, the computer program product comprising:
a first program code for specifying key information used for generating the XML signature;
a second program code for adding a index of signature targets to the XML signature;
a third program code for, when the XML signature is instructed, using the specified key information, thereby obtaining a summary value of the specified signature target, and generating the XML signature including the summary value; and
a fourth program code for embedding the generated XML signature in an original XL document, and outputting a signed XML document.

15. A computer program product used for a computer capable of executing an application having an XML document processing function, comprising a computer readable storage medium having stored therein a program for applying an XML document to the created XML document, the computer program product comprising;
a first program code for syntax-analyzing a received XML document;
a second program code for, when the XML document includes an XML signature as a result of the syntax analysis, verifying the XML signature, and outputting the verification result;
a third program code for, when the verification is carried out, outputting the fact that signature verification is invalid if a verification process of target is incomplete; and
a fourth program code for, when an address of a signature target is specified for a signature target of the signature verification incomplete, reading the specified signature target, verifying the XML signature, and outputting the verification result.

16. A method for exchanging an XML signature, over Internet carried out between a Web server for providing a home page and a Web browser capable of inputting information by browsing the home page, the Web server comprising:
when a signed XML document is transmitted in which a signed XML document in standard specification is assigned to an XML document generated based on input document over the Web browser, receiving the signed XML document;
verifying an XML signature of the received, signed XML document;
if the XML signature is valid as a result of the verification, generating an XML document that notified acceptance of the signed XML document;
assigning an XML document to this XML document, thereby generating the signed XML document; and
transmitting the signed XML document to the Web browser.

17. A method for exchanging an XML signature, of an XML document managed by a Web server communicable with a client, the method comprising:
receiving a request for signifying the managed XML document from a client;
transmitting the managed XML document to the client; and
displaying a screen for prompting selection of the XML document targeted for signature.

18. A method for exchanging an XML signature, in an ASP service that is established between an ASP's Web server for providing an ASP service that includes creation/management of an XML document and a client's Web browser utilizing the ASP service, the method comprising:
transmitting an XML document created/managed by the ASP's Web sever to the client's Web browser;
assigning a signature over the client's Web browser to the received XML document from the ASP's Web server, thereby generating a signed XML document; and
returning the signed XML document to the ASP's Web server.

19. A method for exchanging an XML signature, established between an application for creating an XML document with an XML signature template and a signature assigning server to the XML document, the signature assigning server comprising:
storing an XML document with a template received from the application;
when a signature assignment permission is received with respect to the stored XML document, assigning the signature to the XML document, thereby generating the signed XML document; and
returning the signed XML document to the application.

20. A computer program product used for a second computer communicable with a first computer on which an application for carrying out document processing operates, comprising a computer readable storage medium having stored therein a program for receiving an XML document with a template of an XML signature from the first computer, and assigning a signature to the XML document, the computer program product comprising:
a first program code for storing the XML document with the template received from the first computer;
a second program code for, when permission of signature assignment is received with respect to the stored XML document, assigning the signature to the XML document, thereby generating a signed XML document; and
a third program code for returning the signed XML document to the first computer.

21. A computer program product according to claim 20, wherein the template includes signature target information for specifying a signature target and signer's public key information.
